(19) United States
(12) Patent Application Publication
(10) Pub. No.: US 2026/0233392 A1
(43) Pub. Date: Aug. 13, 2026

(54) CONTROL SYSTEM, CONTROL METHOD, AND RECORDING MEDIUM

(71) Applicant: NEC Corporation, Tokyo (JP)

(72) Inventors: Mineto SATOH, Tokyo (JP); Rui ISHIYAMA, Tokyo (JP)

(73) Assignee: NEC Corporation, Tokyo (JP)

(21) Appl. No.: 19/160,056

(22) PCT Filed: Mar. 2, 2023
(86) PCT No.: PCT/JP2023/007778

§ 371 Date: Aug. 27, 2025

(51) Int. Cl. B25J 9/16; B25J 13/08; B25J 19/02

(52) U.S. Cl. CPC B25J 9/1661; B25J 9/1697; B25J 13/089; B25J 19/023

(57) ABSTRACT

A control system according to the present invention comprises: determining whether or not to change a relation in position and orientation between an observation device for realizing a desired task which is input through an input device and a workpiece to be subject to the desired task, on the basis of at least one of information pertaining to the desired task, observation device information pertaining to the observation device, object model information pertaining to the workpiece, controlled device information pertaining to a controlled device for changing the relation in position and orientation between the observation device and the workpiece, and constraint condition information to be satisfied for realizing the desired task; and controlling the controlled device to execute the desired task.

### TECHNICAL FIELD

The present disclosure relates to a control system, a control method, and a recording medium.

### BACKGROUND ART

An example of a controlled device controlled by a control device is disclosed in PTL 1, for example. The robot device disclosed in PTL 1 generates an operation with a short operation time while considering both the order of moving a tip (end effector) of the robot device used for appearing inspection or the like, that is, the imaging device to the work point and the posture of the tip at that time.

### CITATION LIST

### Patent Literature

PTL 1: WO 2021/070096 A1

### SUMMARY OF INVENTION

### Technical Problem

However, in a case where the relation between the tip of the robot device and the work target object (workpiece) is not ideal, that is, in a case where the tip cannot reach the position, the position is out of the field of view of the imaging device of the tip, or the work target object is shielded by another object (that is, the another object is an object other than the work target object (workpiece) and can be operated by the control device (at least one of the position and the posture can be changed)), it is difficult to operate the tip only by planning the order and the posture of the tip. Therefore, the device disclosed in PTL 1 cannot always control the tip when the relation between the tip of the robot device to be controlled and the work target object is not ideal. Therefore, an object of the present disclosure is to provide an operation plan in which control can be continued and work can be performed even when a relation between a tip (end effector) of a robot device and a work target object is not ideal.

### Solution to Problem

A control system according to an aspect of the present disclosure includes a first processing means for determining, based on at least one piece of information of information about an objective task input by an input device, observation device information about an observation device that achieves the objective task, object model information about a workpiece to be subject of the objective task, controlled device information about a controlled device that changes a relation in position and posture between the observation device and the workpiece, and constraint condition information to be satisfied for achieving the objective task, whether to change the relation in position and posture between the observation device and the workpiece, a second processing means for determining whether the observation device is allowed to observe the workpiece, a third processing means for outputting, based on a result of determination by the second processing means, plan information for executing the objective task, and a fourth processing means for controlling the controlled device based on the plan information.

A control method according to another aspect of the present disclosure includes determining, based on at least one piece of information of information about an objective task input by an input device, observation device information about an observation device that achieves the objective task, object model information about a workpiece to be subject of the objective task, controlled device information about a controlled device that changes a relation in position and posture between the observation device and the workpiece, and constraint condition information to be satisfied for achieving the objective task, whether to change the relation in position and posture between the observation device and the workpiece, determining whether the observation device is allowed to observe the workpiece, outputting, based on a determination result, plan information for executing the objective task, and controlling the controlled device based on the plan information.

A recording medium according to another aspect of the present disclosure stores a program for causing a computer to execute the steps of determining, based on at least one piece of information of information about an objective task input by an input device, observation device information about an observation device that achieves the objective task, object model information about a workpiece to be subject of the objective task, controlled device information about a controlled device that changes a relation in position and posture between the observation device and the workpiece, and constraint condition information to be satisfied for achieving the objective task, whether to change the relation in position and posture between the observation device and the workpiece, determining whether the observation device is allowed to observe the workpiece, outputting, based on a determination result, plan information for executing the objective task, and controlling the controlled device based on the plan information.

### Advantageous Effects of Invention

According to the device and the like of the present disclosure, it is possible to achieve precise control of the controlled device.

### BRIEF DESCRIPTION OF DRAWINGS

FIG. 1 is a diagram illustrating an example of a configuration of a control system according to the first example embodiment of the present disclosure.

FIG. 2 is a diagram illustrating an example of a data structure of storage information stored in the storage device according to the first example embodiment of the present disclosure.

FIG. 3 is a flowchart illustrating an example of a procedure of processing performed by the control system according to the first example embodiment of the present disclosure.

FIG. 4 is a diagram illustrating an example of display of a task input screen according to the first example embodiment of the present disclosure.

FIG. 5 is a diagram illustrating an example of a specific configuration of a control system according to the first example embodiment of the present disclosure.

FIG. 6A/B is a diagram illustrating a first example of an abstraction state according to the first example embodiment of the present disclosure.

FIG. 7A/B is a diagram illustrating a second example of an abstraction state according to the first example embodiment of the present disclosure.

FIG. 8 A/B is a diagram schematically illustrating an example of a change in a logical variable assuming a result of solving an optimization problem in an example embodiment of the present disclosure and an operation related to the example of the change.

FIG. 9A/B is a diagram illustrating an example of another abstraction state in a case where an objective task is an imaging task in the first example embodiment of the present disclosure.

FIG. 10A/B is a diagram schematically illustrating an example of a change in each logical variable and an operation related to the example of the change when the constraint condition of Expression (10) is added to solve the optimization problem in the example embodiment of the present disclosure.

FIG. 11 is a diagram illustrating an example of a configuration of a control system according to the second example embodiment of the present disclosure.

FIG. 12 is a diagram illustrating an example of a configuration of a control system according to the third example embodiment of the present disclosure.

FIG. 13 is a diagram illustrating a first application example of the control system according to the first example embodiment of the present disclosure.

FIG. 14 is a diagram illustrating a second application example of the control system according to the first example embodiment of the present disclosure.

FIG. 15 is a diagram illustrating a third application example of the control system according to the first example embodiment of the present disclosure.

FIG. 16 is a diagram illustrating a control system having a minimum configuration according to an example embodiment of the present disclosure.

FIG. 17 is a diagram illustrating an example of a processing flow of a control system having a minimum configuration of the present disclosure.

FIG. 18 is a schematic block diagram illustrating a configuration of a computer according to at least one example embodiment.

### EXAMPLE EMBODIMENT

Hereinafter, example embodiments of the present disclosure will be described, but the following example embodiments do not limit the invention according to the claims. Not all combinations of features described in the example embodiments are essential to the solution of the present disclosure. In the following description and drawings of the example embodiment, the same reference numerals denote the same things unless otherwise specified. In the following description of the example embodiment, repeated description of similar configurations or operations may be omitted.

### <First Example Embodiment

### (Configuration)

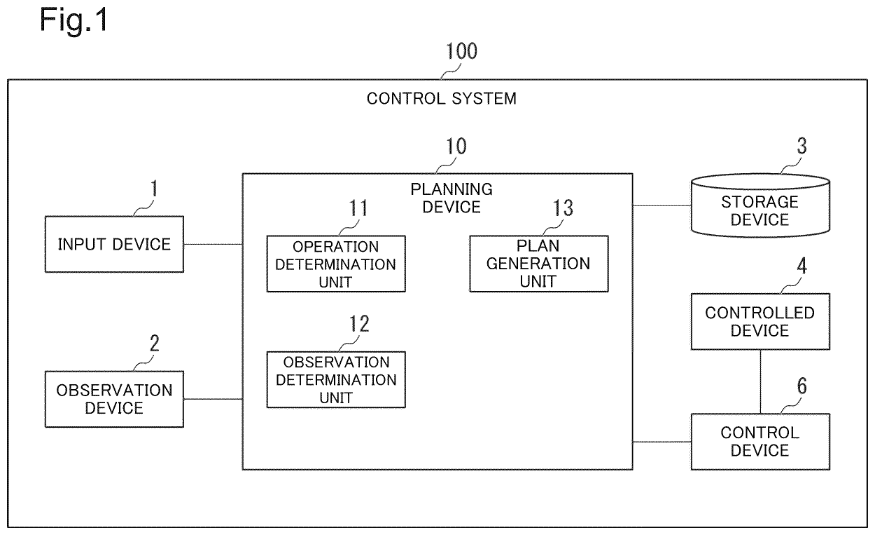

FIG. 1 is a diagram illustrating an example of a configuration of a control system 100 according to the first example embodiment of the present disclosure. As illustrated in FIG. 1, the control system 100 includes an input device 1, an observation device 2, a storage device 3, a controlled device 4, a control device 6 (an example of a fourth processing means), and a planning device 10. The control system 100 is a control system that controls the controlled device 4 by causing the planning device 10 to output information for changing a positional relation between the observation device 2 and a target object to be described later based on information for the control system 100 to execute work (task) and information stored in the storage device 3.

The input device 1 receives an input of information necessary for causing control system 100 to execute work (task). Hereinafter, this task is referred to as an “objective task”. The input device 1 may function as an interface with the user and receive data input by the user. For example, the input device 1 may include a graphical user interface (GUI) and include at least one of a touch panel, a button, a keyboard, and a voice input device.

The observation device 2 observes a target object (workpiece) to be a subject of the objective task in accordance with the objective task received by the input device 1. The observation of the workpiece is a generic term for acquiring information about the workpiece by the observation device 2. For example, in a case where the objective task is to obtain image information about a workpiece, the observation device 2 includes a camera. A camera (two-dimensional camera or three dimensional camera) acquires a still image or a continuous image from a specific position and a specific posture. The information about the acquired image includes at least one of an RGB image, 3D depth data, and point cloud data, and may be appropriately set according to the objective task. The setting is processing of substituting acquired information represented by a numerical value into a variable. A camera that can acquire information of a desired image may be used, and is not limited in the present disclosure. The objective task for obtaining such image information can be applied to, for example, workpiece inspection and management, data collection for machine learning, or the like. The machine learning is, for example, learning for object recognition (estimating a position and a posture of an object from an image) or object identification (discriminating a specific object from an image). As an example of another objective task, it is conceivable to obtain information about a workpiece using the observation device 2 as a dedicated sensor. For example, an application in which the observation device 2 is a barcode reader and a barcode attached to a workpiece is read, and an application in which the observation device 2 is a microscope camera (microscope) and a surface pattern (object fingerprint) of a workpiece is imaged can be considered. The dedicated sensor of the observation device 2 and the acquired information are not limited thereto, and are not limited in the present disclosure. The installation location and the installation number of the observation devices 2, a movable (control) method, and the like may be appropriately determined according to the objective task. Details of a method of controlling the observation device 2 will be described later.

The storage device 3 stores at least information about an objective task to be executed by the control system 100. Specifically, for example, the storage device 3 stores information about the observation device 2, information about a workpiece to be a subject of the objective task, and information about the controlled device 4. Examples of the information about the objective task include a condition for completing the objective task received by the input device 1, a constraint condition to be satisfied, and the like. Specifically, in the case of the objective task for obtaining image information about the workpiece described above, the information about the objective task is a condition (imaging condition) such as a relation in position and posture between the workpiece and the observation device 2, for example, a distance to and a posture of the workpiece, brightness, and the like at the time of imaging, a condition about an environment in a work space such as “the space between the workpiece and the observation device 2 is not shielded by another object or the like” or “there is no another object or the like within the movable range of the controlled device 4”, and the like. The information about the objective task may be stored as numerical data, a mathematical expression (an inequality or an equality), or a proposition (a form in which the authenticity of a sentence or an expression can be determined). Examples of the information about the observation device 2 include information about specifications, performance, restrictions, and the like regarding the observation device 2. Specifically, in the case of an objective task for obtaining image information of a workpiece, the information about the observation device 2 is a range in which an image can be captured by the observation device 2, a required time for imaging, a size of the device, and the like. Examples of the information about the workpiece include information designating a shape of the workpiece and an imaged location. The information about the workpiece may be data such as a CAD model or a numerical value indicating a size or the like. Examples of the information about the controlled device 4 include a movable range and a movable speed of the controlled device 4, and information necessary for control. The storage device 3 may be an external storage device such as a hard disk connected to or incorporated in any other device, or a storage medium such as a flash memory. The storage device 3 may be distributed and stored in a plurality of storage devices or a plurality of media.

The controlled device 4 changes the relative positional relation between the observation device 2 and the workpiece based on the operation plan output by the planning device 10. The controlled device 4 will be described by taking the case of the objective task of obtaining the image information about the workpiece as an example. For example, in a case where the controlled device 4 is a robot device (robot arm and articulated robot arm) having a movable arm, the observation device 2 is mounted on the arm, and the arm is moved by a control signal generated by the control device 6 based on the operation plan, whereby the positional relation between the observation device 2 and the workpiece can be changed. Alternatively, by fixing the installation position of the observation device 2 and mounting a gripper having two or more claws or a suction end effector capable of performing suction by vacuum, magnetic force, or the like in response to an operation (manipulation) by physical contact with the workpiece, such as gripping or pushing the workpiece, on the arm of the robot device, it is possible to change the position and the posture of the workpiece or perform an operation of gripping the workpiece and bringing the workpiece closer to the observation device 2. As a result, the controlled device 4 can change the positional relation between the observation device 2 and the workpiece. Alternatively, mounting the observation device 2 and the end effector on the arm, it is possible to change both the position and the posture of the observation device 2 and the position and the posture of the workpiece. The above-described controlled device 4 is an example, and the type and configuration of the arm, the mounting method and the number of the observation devices 2, the type of the end effector, and the like may be appropriately determined according to the objective task and the type of the workpiece. Furthermore, as an example of another controlled device 4, the controlled device may be integrated into the observation device 2. For example, the observation device 2 may include a movable unit that changes the imaging range by changing the position and the posture of the observation device 2, and the movable unit may be the controlled device 4. The movable unit is a movable device (including an actuator) that brings about a change in rotation or translation other than the arm in the robot device. The movable method, configuration, and the like of the observation device 2 may be appropriately determined according to the observation device 2, the objective task, and the type of the workpiece.

The control device 6 generates a control signal for controlling the controlled device 4 based on the operation plan. The control device 6 controls the controlled device 4 by outputting the generated control signal to the controlled device 4. The control device 6 may be a device independent of the controlled device 4. The control device 6 may be a device provided in the controlled device 4.

The planning device 10 includes an operation determination unit 11 (an example of a first processing means), an observation determination unit 12 (an example of a second processing means), and a plan generation unit 13 (an example of a plan generation means). The planning device 10 outputs an operation plan (an example of plan information) for controlling the controlled device 4 based on information input from each of the input device 1, the observation device 2, and the storage device 3 (specifically, based on processing in an optimization problem to be described later,). The planning device 10 may be a device independent of the input device 1, the observation device 2, the storage device 3, the controlled device 4, and the control device 6. The planning device 10 may be coupled to any of the input device 1, the observation device 2, the storage device 3, the controlled device 4, and the control device 6. The connection between the planning device 10 and each of the input device 1, the observation device 2, the storage device 3, the controlled device 4, and the control device 6 may be wired or wireless.

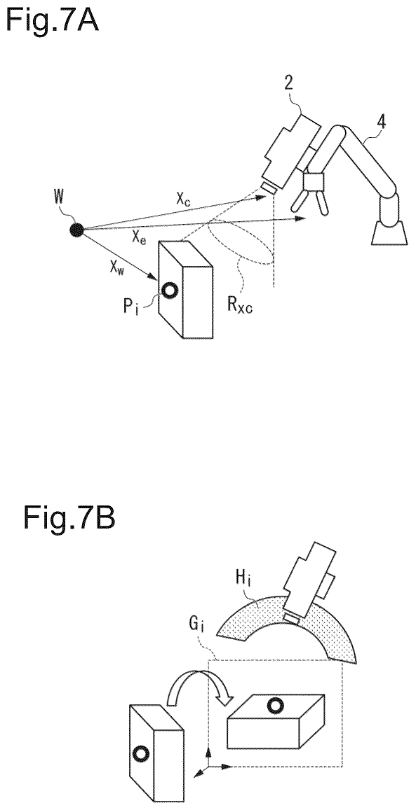

The operation determination unit 11 receives the state information about the current environment and the information stored in the storage device 3 to output a determination result as to whether to operate the object. The state information about the current environment is, for example, information indicating the position and the posture of the workpiece. The position and the posture are expressed in a coordinate system based on the observation device 2 or the controlled device 4, or in a coordinate system based on any point. The position and the posture are desirably represented by a total of six dimensions of information in which the position is represented by the three dimensions (X, Y, Z) and the posture is represented by the three dimensions (roll, pitch, yaw). It is assumed that a positional relation (that is, the coordinates of each of the observation device 2, the controlled device 4, and the any point in the coordinate system to be applied.) between the observation device 2, the controlled device 4, and any point is known. The representation of the position and the posture of the workpiece is not limited to the above, and may be, for example, the center or the center of gravity position and the size of the workpiece. This is, for example, a case where “the widest surface is set as the imaged location” illustrated in FIG. 7A/B to be described later, and it can be seen from the state of the workpiece that the widest surface of the workpiece does not face the observable direction of the observation device 2 in the state of the workpiece illustrated in FIG. 7A/B. In a case where another object exists in the environment in which the objective task is executed, the state information about the current environment includes information indicating the position and the posture of the object. In other words, in a case where there is another object in the environment in which the objective task is executed, the state information about the current environment is recognition information about the object existing in the environment in which the objective task is executed. The recognition information is information including identification of whether the object is a workpiece or another object. This recognition information may be output based on the information acquired by the observation device 2 or may be acquired from another recognition means. Examples of another recognition means include a device different from the observation device 2 (for example, a device existing outside the observation device 2). The another recognition means recognizes a workpiece or another object using, for example, an inference device trained in advance by machine learning (deep learning) using a neural network.

As described above, the storage device 3 stores at least information about the objective task to be executed by the control system 100. The storage device 3 may store information about the observation device 2, information about a workpiece to be a subject of the objective task, and information about the controlled device 4. Hereinafter, an example in which an imaging task for obtaining image information about a workpiece is an objective task will be described. However, the above information is an example, and the information input as the information stored in the storage device 3 is not limited to the above. For example, a proposition for completing the objective task may be input to the information stored in the storage device 3. The operation determination unit 11 determines whether to operate the object based on the state information about the current environment and the information stored in the storage device 3. The operation determination unit 11 outputs the determination result to the plan generation unit 13. To operate an object means, in a case where the workpiece included in the environment and another object are recognized, to operate the object, including the another object, that is, to change the position and the posture of the object. The determination result may be a numerical value or a binary value representing true or false. The number of determination results is not limited to one. For example, as described above, in a case where another object is included, the operation determination unit 11 may independently output the determination result of operating the workpiece and the determination result of operating the another object. The determination result output by the operation determination unit 11 may be, for example, true or false for the proposition “operate the workpiece”.

The observation determination unit 12 receives information about the abstraction state and information about the observation device 2. The observation determination unit 12 determines whether the observation device 2 enters a region where the observation device 2 is allowed to observe a workpiece 20 based on the information about the workpiece, the information about the observation device, and the proposition. For example, in the case of a configuration in which the observation device 2 is movable or the position and the posture of the workpiece 20 are controlled, the observation determination unit 12 determines that observation is possible when the observation device 2 enters the region where the workpiece 20 can be observed. For example, in a case where the installation position of the observation device 2 is fixed, the observation determination unit 12 determines that observation is possible when a workpiece enters the region that the observation device 2 can observe. The determination result may be a binary value representing true or false or other values. Examples of other values include an overlap ratio between the region observable by the observation device 2 and the volume or the region of the workpiece 20. For example, the observation determination unit 12 may output true or false for the proposition “observable”. The observation determination unit 12 outputs the determination result. As in the information input to the operation determination unit 11, the workpiece state information is information indicating the position and the posture of the workpiece. The information stored in the storage device 3 is information including at least specifications, performance, or restrictions on the observation device 2. However, the above information is an example, and the information input as the information stored in the storage device 3 is not limited to the above. For example, a proposition for completing the objective task may be input to the storage device 3.

The plan generation unit 13 receives state information about the current environment, information stored in the storage device 3, a determination result by the operation determination unit 11, and a determination result by the observation determination unit 12 to output an operation plan for controlling the controlled device 4 to the control device 6. This operation plan is obtained, for example, based on processing in an optimization problem to be described later. As in the information input to the operation determination unit 11, the state information about the current environment is information indicating the positions and the postures of the workpiece and another object. The state information about the current environment includes information about an object other than the workpiece 20. The information input to the operation determination unit 11 does not include information about an object other than the workpiece 20. The information stored in the storage device 3 includes at least information about an objective task to be executed by the control system 100. Hereinafter, an imaging task for obtaining image information about a workpiece, which is an example of an objective task, will be described. As the information about the imaging task stored in the storage device 3, a condition or a proposition for completing the objective task is input. For example, the information about the imaging task stored in the storage device 3 is a proposition such as “the observation device 2 is in the observable region”, “there is no object to obstruct between the workpiece and the observation device 2”, and “the current state of the workpiece satisfies the designation of the imaged location”. Output of any one of the operation determination unit 11 and an imaging determination unit 12 is related to each set one proposition, and authenticity of the proposition is determined. The plan generation unit 13 outputs an operation plan for controlling the controlled device 4 to the control device 6 based on the determination result for this proposition. The operation plan is desirably an operation plan for changing the relation in position and posture between the observation device 2 and the workpiece and the object in time series, that is, for each time step. Specifically, the plan generation unit 13 generates information to move the object to a specific position, move the workpiece to a specific position, or move the observation device 2 to a specific position for each time step. As will be described later, the plan generation unit 13 generates the information, that is, a specific position to which they are moved by determining whether to move for each time step, as a value of a state vector in an abstraction model (for example, Expressions (6) and (7) to be described later). The plan generation unit 13 outputs the information generated for each time step to controlled device information 14. That is, the operation plan includes information about the order (sequence) of each operation. The controlled device 4 is controlled based on these pieces of time series information, but the operation plan may not be a control signal that directly controls a movable unit (actuator) of the controlled device 4. For example, the operation plan may include information about a target value of the position and the angle of the movable unit at a certain time step, and control up to the target value may be achieved by a control function included in the control device 6 or the controlled device 4 of this configuration. Generally, current state information (position and angle) of the controlled device 4 can be acquired from the controlled device 4. Therefore, by providing the target value by the operation plan, it is possible to achieve control from the current value to the target value, for example, control for feeding back the angle of the movable unit (actuator) in such a way as to follow spatially continuous position information (track).

### (Storage Information)

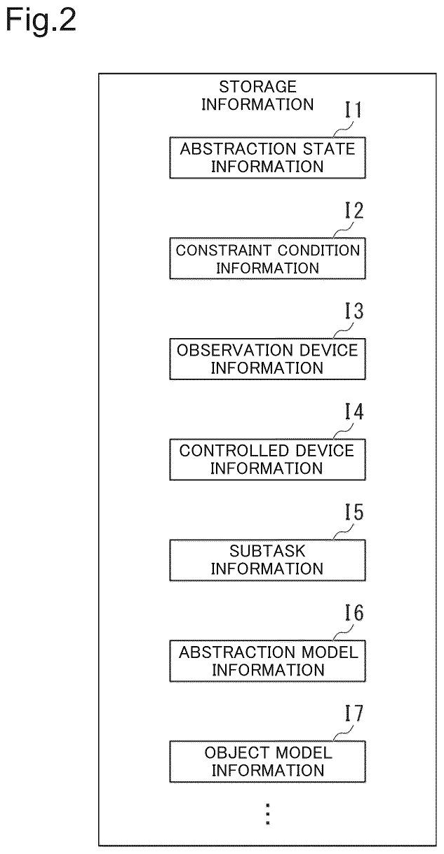

Although it is described above that the storage device 3 stores at least information about the objective task to be executed by the control system 100, and stores information about the observation device 2, information about a workpiece to be a subject of the objective task, and information about the controlled device 4, these will be specifically exemplified below. FIG. 2 is a flowchart illustrating an example of a procedure of processing performed by the control system 100 according to the first example embodiment of the present disclosure. As illustrated in FIG. 2, the storage device 3 may store abstraction state information I1, constraint condition information I2, observation device information I3, controlled device information I4, subtask information I5, abstraction model information I6, and object model information I7.

The abstraction state information I1 is information about an abstraction state that is required to be defined to control the controlled device 4. The abstraction state is a state in which a real object in a work space in which the control system 100 is operated is abstracted and indicated. For example, the abstraction state is information representing the position, posture, size, and other features of the object as numerical values. However, the abstraction state is not limited thereto. For example, the abstraction state may be information represented by a function (for example, Gaussian distribution or the like) representing a distribution of positions or a surface shape.

The type and content of the objective task input from the input device 1 may be associated with an abstraction state that is required to be defined. For example, in a case where the objective task is an imaging task for obtaining image information about a workpiece, a position of the workpiece, a posture of the workpiece, a size of the workpiece, a position of another object, a posture of another object, a size of another object, a position of an obstacle that should not be contacted, a posture of an obstacle that should not be in contact, a size of an obstacle that should not be contacted, a region of an obstacle that should not be contacted, a position of the observation device 2, a posture of the observation device 2, a size of the observation device 2, and the like are stored as the abstraction state information I1. The region of the obstacle that should not be contacted may be a region with a margin equal to or larger than the actual size of the obstacle that should not be contacted. The abstraction state information I1 may be stored in advance before the objective task is executed, or may be updated when information is added. The means for adding information may be any means.

The constraint condition information I2 is information indicating a constraint condition when the objective task is executed. The constraint condition information I2 is information indicating that, for example, in a case where the objective task is the above-described imaging task, the observation device 2 should not come into contact with a workpiece, the observation device 2 should not come into contact with another object or an obstacle, and a subject controlled by the controlled device 4 should not enter a certain range (region). The conditions indicated by these pieces of information may be defined as numerical data (absolute value/relative value) or in a mathematical expression (inequality or equality) based on each abstraction state. The conditions indicated by these pieces of information may be stored in propositions (a manner in which the authenticity of sentences or expressions can be determined), or may include a condition regarding an order between propositions. The type and content of the objective task input from the input device 1 may be associated with the constraint condition information I2.

The observation device information I3 is information indicating specifications and performance of the observation device 2. The observation device information I3 may include information associated with the objective task and the type of the observation device 2. For example, in a case where the objective task is an imaging task and the observation device 2 is a camera, the information associated with the objective task and the type of the observation device 2 included in the observation device information I3 is information such as a visual field range, a focal length, a focal depth, and a necessary light amount of the camera.

The controlled device information I4 is information indicating specifications and performance of the controlled device 4. The controlled device information I4 may include information in which the objective task, the configuration of the control system 100, and the type of the controlled device 4 are associated with each other. For example, in a case where the controlled device 4 is a robot arm, the information is parameter information such as a movable range, a limit value of a movable speed, and a gain necessary for control. These pieces of information may be values at the time of shipment determined by hardware of the controlled device 4, or may be values set by the user according to the objective task or the configuration of the control system 100.

The subtask information I5 indicates information that is associated with the objective task and the configuration of the control system 100 including the observation device 2 and the controlled device 4, and for the plan generation unit 13 to output the operation plan. The objective task is executed by combining tasks defined in units in which the controlled device 4 can operate. Hereinafter, the identified task is referred to as a subtask. The combination of subtasks is determined based on the plan information output by the plan generation unit 13. That is, the subtask information I5 includes information indicating a correspondence relation between information defining a subtask and plan information, and is referred to in the processing of plan information output by the plan generation unit 13. In a case where the objective task is, for example, an imaging task given as “finally capturing an image of a designated location of a workpiece”, the subtasks are, for example, a “subtask (ST1) of approaching a position of a workpiece or an object” in a case where another object exists, a “subtask (ST2) of changing a position and a posture of an object”, a “subtask (ST3) of changing a position and a posture of a workpiece” to be changed in a case where a current position and a current posture of the workpiece do not satisfy a condition under which an image can be captured, a “subtask (ST4) of grasping a workpiece and bringing the workpiece closer to the observation device 2” in a case where an installation position of the observation device 2 is fixed, and the like. For example, in the subtask ST1, the target value is received in a task of moving the designated position of the arm of the controlled device 4 to the target value. Therefore, the information defining the subtask stored in the subtask information I5 includes information for performing control from the current value to the target value. In the subtask ST2, the target position and the target posture are received in a task of changing the current position and the current posture of the object to the target position and the target posture using the end effector of the controlled device 4. The information defining the subtask stored in the subtask information I5 includes information for performing control from the current position and the current posture to the target position and the target posture. The plan generation unit 13 selects an appropriate subtask based on the plan information output according to the difference between the objective task and the environment and the correspondence relation defined in the subtask information I5, and combines the selected subtasks. In the above case, for example, the plan generation unit 13 combines the subtasks of approaching the object (ST1), changing the position and the posture of the object (ST2), and bringing the workpiece 20 closer to the observation device 2 (ST4).

The subtask information I5 may include an adjustment parameter such as a time required for completing the execution of the subtask, a speed at the time of executing the subtask, and the like, a constraint condition of an order relation between the subtasks, and the like. The subtask information I5 does not need to include information for generating a control signal for directly controlling the controlled device 4. The signal for controlling the controlled device 4 may be associated with the operation plan output by the plan generation unit 13, a subtask to be executed can be determined from the operation plan and the signal may be generated based on the subtask. The method of determining a subtask from the plan information is a method using a relation between a change in a logical variable and a subtask described later. In this case, the controlled device 4 is only required to have a function of being controlled from the current state to the target value when, for example, a state change target object (the workpiece 20, an obstacle 21 to be described later, the observation device 2, and the like) whose position and posture are changed by the controlled device 4 and the target value are designated related to each subtask. That is, the controlled device 4 may be controlled from a current state to a target value by a general control device (controller) not illustrated in FIG. 1.

The subtask information I5 desirably has information about a function of controlling the controlled device 4 according to the input value according to the subtask. Specifically, in the example of the subtask ST1 described above, the subtask information I5 is information about a function that generates a track (a point where the designated position of the arm spatially passes) from the current value to the target value using the current value and the target value as arguments. The subtask information I5 is not limited to the above function, and may include information of a table (database) that outputs a track based on a current value and a target value. In the case of the suitable subtask information I5, each movable unit (actuator) of the controlled device 4 is controlled in such a way as to satisfy the track information. This control is achieved by the control device 6 illustrated in FIG. 1. The difference between the subtask information I5 including the information about the table (database) that outputs the track based on the current value and the target value described above and the suitable subtask information I5 is whether the information given to the controlled device 4 by the planning device 10 is the target value or the track information. The target value is spatially single information. On the other hand, the track is continuous information. Therefore, by providing the subtask information I5 including the information about the table (database) for outputting the track to the controlled device 4, the spatial control accuracy of the controlled device 4 can be enhanced. This contributes to achievement of an appropriate subtask, that is, improvement of achievement of a target task.

The abstraction model information I6 is information related to a model (also referred to as an “abstraction model”) obtained by abstracting dynamics in the work space of the control system 100. The abstraction model is not limited to a model obtained by abstracting continuous dynamics as handled in a mechanical system, and may mix with a model obtained by abstracting discrete dynamics including logic. In general, a system represented by a system (that is, an overall model including an abstraction model indicating a state of a target object or an environment and its dynamics) targeted by the control system 100 is referred to as a hybrid system. Therefore, the abstraction model information I6 may include information related to switching of dynamics in the above-described hybrid system, that is, branching of logic. “Switching” means that an abstraction model changes due to logical branching. As the switching condition, for example, in a case where the objective task is the above-described imaging task, imaging is performed when the observation device 2 enters a region where the workpiece 20 can be observed, or the workpiece is grasped and the position and the posture of the workpiece are changed when the end effector of the controlled device 4 approaches the workpiece or another object to a prescribed position. The abstraction model information I6 is desirably expressed as a state space model representing dynamics of a hybrid system including a continuous variable and a discrete (logical) variable. The dynamics is “dynamic behavior (change)” contrasted with “static behavior (change)”. The state space model is a model representing spatial and temporal changes (dynamic, i.e. dynamic change) in a state (position and posture). The abstraction model information I6 may be stored in association with the type and content of the objective task and the configuration of the control system 100. The type of the objective task represents a difference in hardware such as an observation device and a controlled device according to a difference in the objective task itself such as imaging, inspection, and identification. The content of the objective task represents a difference in operation in the same objective task such as the number of times of imaging and the number of workpieces.

The object model information I7 is information for designating a shape and an imaged location of the workpiece 20 to be a subject of the objective task. The imaged location is a portion (for example, an upper face of the workpiece 20 when the workpiece 20 is viewed from above, or the like) of the workpiece 20 to be imaged. The imaged location is information that can be designated by a region, a coordinate value, a feature (such as a vertex), and the like. The object model information I7 may include information about another object and an obstacle. The information about another object and an obstacle is information for an operation such as operating (controlling) the controlled device 4 so as not to collide with another object and an obstacle, or “moving” the another object, the obstacle, and the workpiece 20. Specifically, the information about another object and an obstacle is information for estimating states (position and posture) and sizes of another object and an obstacle. For example, in the case of a known object, the information about another object and an obstacle is CAD data or the like as in the workpiece 20. For example, in the case of an unknown object, the information about another object and an obstacle is information machine-trained as in the workpiece 20. The information about another object and an obstacle may be the same as that about the workpiece 20 except that it does not need only the “imaged location”. The object model information I7 is used for determination by the operation determination unit 11 and output of the operation plan by the plan generation unit 13. The object model information I7 is, for example, information indicating the type, shape, and posture of each object, information such as CAD data indicating a two-dimensional or three dimensional shape, or the like. Information indicating the type, shape, and posture of each object, and information such as CAD data indicating the two-dimensional or three dimensional shape may be recorded as the object model information I7 in association with the type and content of the objective task, the type of the workpiece as a subject, and the like. In order to obtain the state information about the current environment, that is, the state information about the workpiece and another object, information indicating the type, shape, and posture of each object and information such as CAD data indicating a two-dimensional or three dimensional shape may be used in the operation determination unit 11 and the plan generation unit 13. When the operation determination unit 11 and the plan generation unit 13 recognize a workpiece or another object using an inference device trained in advance by machine learning (deep learning) using a neural network, they may include parameters of the inference device and the like. The inference device receives imaging information (2D or 3D) including an object to output state information (position and posture) about the object. Typically, a relation between the imaging information and the correct state information is learned in advance by deep learning (learning using a neural network) (that is, the weight of the neural network is determined as a parameter, and the determined parameter is stored), and the inference device infers the state information from the imaging information using the parameter. The recognition processing may be executed by the control system 100 of the present example embodiment or may be executed by another means. Storage and use of the object model information I7 are not limited in the present invention. For example, when the recognition processing is executed by another means, the object model information I7 may not be used. However, when an “appropriate region Gi” for a determination process by the operation determination unit 11 to be described later is determined, information about the workpiece in the object model information I7 is used.

Although the example of the data stored in the storage device 3 is described above, storage (input) and use (output) of the data may be performed by a device (for example, a device external to the control system 100) different from the storage device 3. In this case, the timing and means of storage (input) and use (output) of data performed by a device different from the storage device 3 are not limited to specific timing and means. In addition, although the information I1 to 17 are presented, instead of using all of these pieces of information, they may be added or omitted as appropriate according to the objective task or the configuration and environment of the control system 100. For example, essential information in the configuration and environment of only a certain objective task and a workpiece is the abstraction state information I1, the abstraction model information I6, the subtask information I5 based on the objective task, the object model information I7 (workpiece), the observation device information I3, and the controlled device information 14 in the configuration and environment. That is, the constraint condition information I2 can be omitted.

### <Operation>

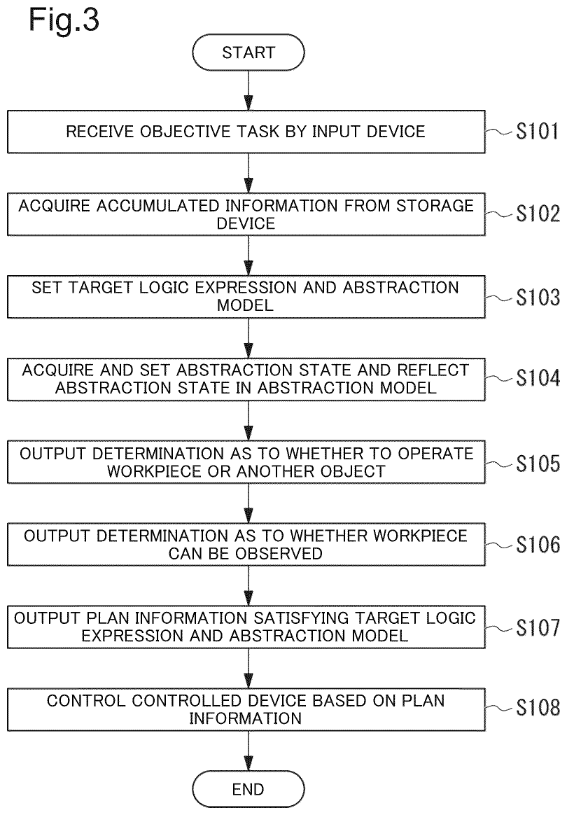

Next, processing performed by the control system 100 will be described. FIG. 3 is a flowchart illustrating an example of a procedure of processing performed by the control system 100. In the processing illustrated in FIG. 3, the control system 100 receives the objective task from the input device 1 (step S101).

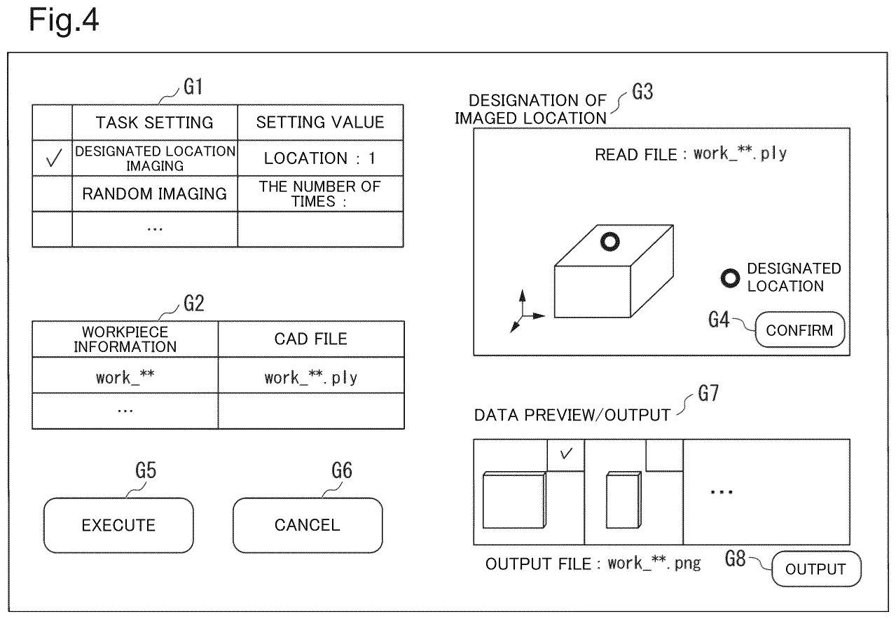

FIG. 4 is a diagram illustrating an example of display of a task input screen according to the first example embodiment of the present disclosure. FIG. 4 is a diagram illustrating an example of receiving an objective task from the input device 1 in a case where the objective task is an imaging task. FIG. 4 illustrates a display example of a user interface (UI) screen that receives an input operation by the user. The input device 1 may include a UI to enable display and input, or the UI may be configured as a device different from the input device 1. In the example illustrated in FIG. 4, a task setting G1 receives selection of a method or a mode of an imaging task and a related setting value. As a mode of the imaging task, there is an option of imaging a designated location or randomly imaging, and the imaged location and the number of images are set as setting values. These options may be displayed and input in a pull-down manner. Workpiece information G2 is information about the size and the shape of the workpiece in the object model information I7 stored in the storage device 3. The example illustrated in FIG. 4 is a reading example from information such as CAD data, and the object model information that is the information about the workpiece read here is displayed in a designation G3 of the imaged location for designating the imaged location illustrated in FIG. 4, and is stored in the storage device 3. The designation G3 is a graphical user interface (GUI) that reads and displays workpiece information (object model information) and designates an imaged location. The imaged location can be designated using a mouse, a touch panel, or the like. Alternatively, as the workpiece information, data (that is, the workpiece information in the object model information I7) stored in advance in the storage device 3 may be read. In this case, the order in which the workpiece information is stored and displayed on the GUI may be any order. The designation G3 of the imaged location indicates the object model information I7 about the read workpiece. In the example illustrated in FIG. 4, the three-dimensional (3D) shape of the workpiece read in the workpiece information G2 and the imaged location (circle mark) are displayed in the designation G3 of the imaged location. The imaged location may be designated by a mouse or the like by three dimensionally rotating the workpiece on the screen of the imaged location designation G3, or information about the imaged location may be included in CAD data or the like read in advance. The designation of the imaged location is finally terminated when the user touches a confirmation button G4. An execution button G5 illustrated in FIG. 4 is a button for instructing start of execution of the objective task. A cancel button G6 illustrated in FIG. 4 is a button for canceling the execution of the objective task. A data preview/output G7 illustrated in FIG. 4 previews the imaged data and outputs the data to a file. In the example illustrated in FIG. 4, the image designated in the data preview/output G7 is output to a designated file by a button G8. The above-described operation on the UI is an example and is not limited in the present invention. For example, although FIG. 4 illustrates an example of a single workpiece and a single imaged location, a plurality of workpieces and a plurality of imaged locations may be provided.

FIG. 2 is a diagram illustrating an example of a data structure of storage information stored in the storage device 3 according to the first example embodiment of the present disclosure. Next, the planning device 10 acquires the accumulated information illustrated in FIG. 2 from the storage device 3 (step S102). The accumulated information is at least information about an objective task to be executed by the control system 100, the objective task being stored in the storage device 3 described above. It is desirable that the planning device 10 acquire associated accumulated information based on the objective task received in step S101 and the configuration of the control system 100, specifically, the observation device 2 and the controlled device 4.

Next, the planning device 10 sets a target logic expression and an abstraction model for the control system 100 to execute the objective task based on the objective task and the accumulated information (step S103). The target logic expression is a logic expression representing a final achievement state to be a target of the objective task. The target logic expression may be expressed in an abstraction state. That is, the target logic expression may be expressed as a variable, and a numerical value may be substituted when information about the actual environment is input. When the calculation is actually performed, a numerical value is substituted into the variable of the target logic expression. In the target logic expression, a condition for completing the objective task and a constraint condition to be satisfied in relation to the environment and the control system 100 may be collectively expressed in one logic expression.

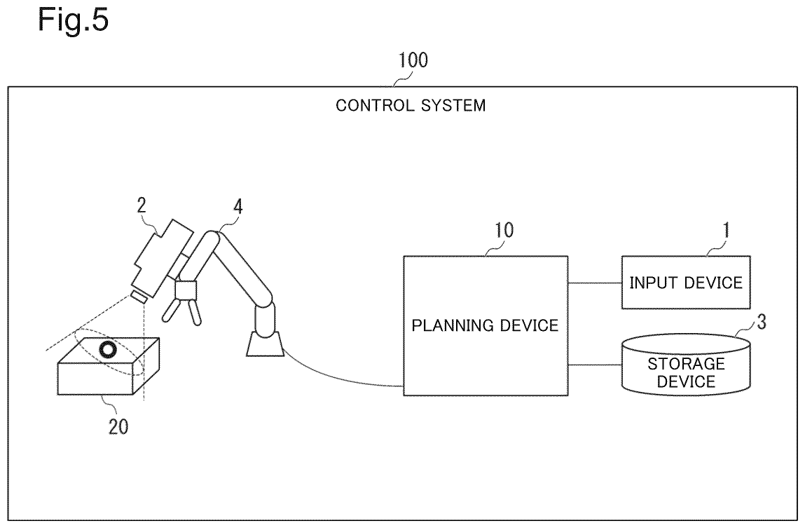

The setting of the target logic expression by the planning device 10 illustrated in FIG. 3 will be described with a specific example. The target logic expression is a logic expression representing a final achievement state as a goal of the objective task acquired by the input device 1 in step S101. FIG. 5 is a diagram illustrating an example of a specific configuration of the control system 100 according to the first example embodiment of the present disclosure. FIG. 5 illustrates an example of a configuration of a control system 100 in a case where an imaging task is set as an objective task in the first example embodiment. FIG. 5 illustrates a configuration of the control system 100 in a case where the observation device 2 is a camera that acquires image information about the workpiece 20, and the controlled device 4 is an arm-equipped robot (robot arm) that changes a relative positional relation between the workpiece 20 and the observation device 2. The observation device 2 is fixedly installed on a robot arm, and the arm of the controlled device 4 is controlled to change the position and the posture of the observation device 2. It is assumed that the robot arm of the controlled device 4 has an end effector capable of holding the workpiece 20 and changing the position and the posture. That is, it is assumed that the position and the posture of the workpiece 20 can be changed by controlling the arm of the controlled device 4. The above configuration is an example and is not limited to this configuration. The more specific process of step S103 described above will be described later.

Furthermore, the planning device 10 acquires current state information about the workpiece 20 to be a subject of the objective task and an object other than the workpiece 20. The planning device 10 reflects the acquired current state information in the abstraction model by setting the acquired current state information as the abstraction state (step S104). The current state information about the workpiece 20 and another object is desirably an amount (for example, a length of a long side) representing the position, posture, and shape. The acquisition means of the current state information may be any means. The more specific process of step S104 described above will be described later.

Next, the operation determination unit 11 outputs a determination result as to whether to operate the object based on the current state information and the information stored in the storage device 3 (step S105). The information stored in the storage device 3 is information about the objective task included in information I7 and information about the workpiece 20 to be a subject of the objective task. Specifically, the information stored in the storage device 3 is desirably a condition under which the workpiece 20 can be imaged or an observation location of the workpiece 20. The more specific process of step S105 described above will be described later.

Next, the observation determination unit 12 outputs a determination result as to whether the observation device 2 enters a region where the observation device 2 is allowed to observe the workpiece 20 based on the state information (information indicating the position and the posture) of the workpiece 20 and the observation device 2 and the information stored in the storage device 3 (step S106). The information stored in the storage device 3 is desirably information about the specification and performance of the observation device 2 including at least the viewing angle and the focal length. There is a case where the above-described essential information cannot be acquired or cannot be actually observed (for example, reflection due to a shadow or ambient light) even when it is determined by calculation from a specification (information). In a case where the essential information cannot be acquired, the observation determination unit 12 may replace the missing information with a prescribed value (a value stored in advance) and make a determination. The observation determination unit 12 actually executes observation based on the plan information, and performs re-planning in a case where the observation has not been performed (the task has not been achieved), or acquires information about another specification (for example, an exposure time or a diaphragm) of the observation device 2 and adjusts the information. The more specific process of step S106 described above will be described later.

Next, the plan generation unit 13 generates an operation plan that satisfies the target logic expression and the abstraction model based on the outputs of the operation determination unit 11 and the observation determination unit 12. The plan generation unit 13 outputs the generated operation plan to the control device 6 (step S107). The more specific process of step S107 described above will be described later.

The control device 6 controls the controlled device 4 based on the operation plan (step S108). The more specific process of step S108 described above will be described later.

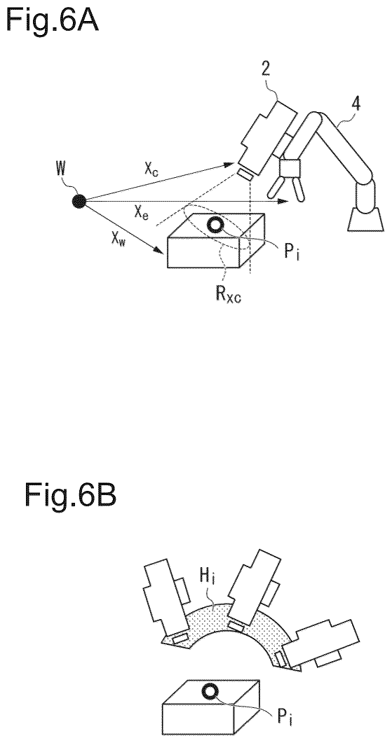

FIG. 6A/B is a diagram illustrating a first example of an abstraction state according to the first example embodiment of the present disclosure. In the drawings and expression including FIG. 6A/B, numerical values are represented by character expression. FIG. 6A illustrates an abstraction state in a case where the imaging task is set as the objective task. In the abstraction state illustrated in FIG. 6A, the reference of the coordinate system is set to a certain point W, and a state vector Xc of the observation device 2, a state vector Xe of the end effector of the controlled device 4, and a state vector Xw of the workpiece 20 are represented. The reference point W can be determined in any manner, and the reference point W can be determined at, for example, an end or a center of the work space, a base on which the robot is placed, or the like. However, in the present disclosure, the reference point W is not limited to the end or center of the work space or the base on which the robot is placed. The state vector is desirably represented by three dimensions (X, Y, Z) indicating the position and three dimensions (roll, pitch, yaw) indicating the posture. The state vector indicates a position and a posture as a reference for each of the observation device 2, the controlled device 4, and the workpiece 20. Therefore, in the following description, a state vector indicating this reference will be described as representing the respective positions and the respective postures. In FIG. 6A/B, the i-th imaged location of the workpiece 20 is expressed as Pi, and the observation range when the observation device 2 is at the position Xc is expressed as Rxc. The observation range Rxc is determined by the viewing angle, the focal length, and the like of the camera stored in the storage device 3 as the observation device information I3. FIG. 6B is a schematic diagram in which the position Xc of the observation device 2 is changed in a range in which the i-th imaged location Pi of the workpiece 20 is included in the observation range Rxc. In a case where the imaged location Pi and the observation range Rxc are known, it is possible to obtain a region (that is, the imageable region) of the position Xc of the observation device 2 when the imaged location Pi is included in the observation range Rxc. The imageable region is expressed as Hi. The imageable region Hi is a range in which the observation device 2 can observe the imaged location Pi when the position Xc of the observation device 2 is changed. Therefore, when the position Xc of the observation device 2 is included in the imageable region Hi, imageable, that is, the objective task can be achieved. In order to express the achievement state of the objective task by a logic expression, the planning device 10 defines a proposition based on the abstraction state information I1. An imaging task that is an objective task for the i-th imaged location Pi defines a proposition “ai” that “the position Xc of the observation device 2 finally exists in the imageable region Hi” as an objective task. “Finally” corresponds to any of the steps up to the final time step set in advance defined by the operator “?” corresponding to “eventually” described later. i is an integer of i≥1, and represents an identification number for identifying an imaged location of the workpiece. A target logic expression is generated using this proposition.

A method of expressing the logic expression will be supplementarily described. As a method of expressing a logic expression, an objective task described in a natural language as described above may be converted into a logic expression and expressed. As a method of converting the objective task into the logic expression, various known methods can be used. As an example of the objective task, a case where the imaging task “the observation device 2 and the imaged location Pi of the workpiece are present in a region A that can be finally imaged” is set will be considered. In this case, the planning device 10 may generate the target logic expression “?al” using the operator “?” corresponding to “eventually” of a linear temporal logic (LTL) expression and the proposition “ai” defined as the achievement state. Specifically, the planning device 10 generates a target logic expression as a constraint condition that Expression (1) is satisfied at a certain time step. The operator “eventually” of the linear temporal logic expression is also referred to as “finally” or “future”, and has a meaning of “sooner or later finally at some time point in the future”. That is, this operator can indicate the passage of time up to the last time point (for example, an assumed finite target time step Tk, which will be described later) without designating a specific time. The target logic expression may be expressed using any linear temporal logic operator other than the operator “?”. The linear temporal logic operator may include a general logical operator. For example, in addition to or instead of eventually “?”, the target logic expression may be generated using the logical product “#”, the logical sum “V”, the negative “!”, the logical inclusion “¥”, always “@”, next “&”, or until “U”, or a combination thereof. The description of the target logic expression may use, for example, a temporal logic such as a metric temporal logic (MTL) or a signal temporal logic (STL) in addition to the linear temporal logic.

A constraint condition that should be satisfied in the execution of the objective task may be added to the target logic expression. For example, the planning device 10 may generate a proposition indicating a constraint condition based on the constraint condition information I2, and generate a target logic expression in the form of one logic expression including the constraint condition using the generated proposition. Alternatively, the planning device 10 may generate a logic expression indicating the constraint condition as a logic expression different from the target logic expression. In this case, it may be determined that the objective task has been achieved by satisfying all of the target logic expression and the constraint condition. When the above-described imaging task is described as an example, the constraint condition that “the controlled device 4 controlled by the control device 6 does not enter the region set as the obstacle” stored as the constraint condition information 12 can be expressed as “@!h” when the proposition that “the controlled unit that is the movable unit of the controlled device 4 exists in the region set as the obstacle” is expressed as “h”. Therefore, the target logic expression for the imaged location Pi including the constraint condition can be generated as “(?ai)#(@!h)”.

As described above, in the configuration of the control system 100 illustrated in FIG. 5 and in the environment in the work space indicated by the abstraction state illustrated in FIG. 6A/B related to the configuration, by satisfying the target logic expression “(?ai)#(@!h)” for the imaged location Pi, the objective task can be achieved while satisfying the constraint condition that the vehicle does not enter the region set as the obstacle.

FIG. 7A/B is a diagram illustrating a second example of an abstraction state in the first example embodiment of the present disclosure. FIG. 7A illustrates an abstraction state in a case where the position and the posture of the workpiece 20 are general as compared with the environment in the work space illustrated in FIGS. 5 and 6. That the position and the posture of the workpiece 20 are general indicates a case where the position of the workpiece 20 is not included in the position of the observation range Rxc illustrated in FIG. 6A/B, that is, a case where the difference between the position of the workpiece 20 and the position of the observation device 2 is equal to or greater than a certain threshold value, and a case where the angle formed between the normal of the surface on which the imaged location Pi exists and the normal of the observation range Rxc is equal to or greater than a certain threshold value, that is, a case where the deviation between the posture of the workpiece 20 and the posture of the observation range Rxc is large. That is, that the position and the posture of the workpiece 20 are general means that the position and the posture are not limited within a certain range. Each threshold value is a value that is appropriately determined depending on the type of the workpiece 20, and the performance, configuration, arrangement, and the like of the observation device 2 and the controlled device 4. Specifically, for example, the threshold value is determined from a value of a specification (a visual field or a focal length) of the observation device 2. Alternatively, for example, the threshold value is determined in such a way as to have a prescribed margin with respect to the value of the specification of the observation device 2. Alternatively, for example, a provisional value is determined as the threshold value without being based on known information such as the specification of the observation device 2. By using the threshold value determined in this manner, the observation determination unit 12 can determine whether the observation device 2 enters a region where the observation device 2 is allowed to observe the workpiece 20 to output the determination result. In the environment in the work space as illustrated in FIG. 7A, in a case where the position Xc of the observation device 2 is not included in the imageable region Hi even when the position Xc is controlled to any value, the above-described target logic expression “(?ai)#(@!h)” cannot be satisfied. That is, the objective task cannot be achieved.

Therefore, in FIG. 7B, an imageable region Hi similar to that in FIG. 6B and two workpieces 20 having different positions and the postures are illustrated. One of the two workpieces 20 is a workpiece 20 similar to the workpiece 20 illustrated in FIG. 7A. The other is a workpiece 20 existing in the appropriate region Gi where the imageable region Hi exists within the movable range of the controlled device 4. In other words, when the workpiece 20 exists in the appropriate region Gi, the controlled device 4 can move to the imageable region Hi, so that the objective task can be achieved. As illustrated in FIG. 7B, the appropriate region Gi is a region including the position and the posture of the workpiece 20.

The appropriate region Gi can be defined such that, for example, the angle formed by the normal vector of the imaged location Pi and the appropriate region Gi is equal to or less than a certain threshold value. By defining the appropriate region Gi in this manner, it is possible to determine the target logic expression in a case where the position and the posture of the workpiece 20 are general. For example, assuming that the proposition “the workpiece 20 is within the range of the appropriate region Gi” is “bi”, the target task can be achieved by further satisfying “(?ai)#(@!h)” in a state where the proposition “bi” is satisfied. That is, the observation device 2 exists in the imageable region Hi in a state where the workpiece 20 exists in the appropriate region Gi, whereby the target task can be achieved. There is a constraint condition in the order of the proposition “ai” and the proposition “bi”. That is, in a case where the observation device 2 exists in the imageable region Hi in a state where the workpiece 20 exists in the appropriate region Gi, the observation device 2 can image the workpiece 20. However, in a case where the workpiece 20 exists in the appropriate region Gi after the observation device 2 exists in the imageable region Hi, there is a possibility that the observation device 2 cannot image the workpiece 20. Therefore, as the constraint condition, when both are satisfied with the proposition “bi” first and the proposition “ai” later, the observation device 2 can reliably image the workpiece 20. Such a constraint condition regarding the order of the propositions may be included in the constraint condition information I2 of the accumulated data illustrated in FIG. 2 or may be included in subtask information I5 to be described later.

Next, more specific process of setting the abstraction model by the planning device 10 in step S103 described above will be described. As described above, the abstraction model is a model obtained by abstracting dynamics in the work space of the control system 100. The abstraction model may be stored as the abstraction model information I6. In order to handle dynamics, that is, temporal change, it is necessary to add a concept of time to the above-described target logic expression. When executing the objective task, the control system 100 counts time in a time step. The control system 100 sets the number of time steps required to execute the objective task, that is, the number of time steps from the start to completion of execution of the objective task. The number of time steps necessary for executing the objective task is also referred to as the target number of time steps. The method of setting the target number of time steps is not limited to a specific method. For example, the target number of time steps may be stored in the storage device 3, or may be designated by the user from the input device 1. The time width of the time step when the control system 100 executes the objective task is not limited to a specific time width.

The above proposition “?ai” is extended in such a way as to include a time step. That is, in a case where the proposition “ai” is satisfied at the time step k (k is an integer of i≥1), it is expressed as “ai,k”. In this case, the proposition “?ai” expressed by the operator “?” (eventually) can be defined by setting a condition that when a target time step at which at least the proposition is satisfied is Tk, a proposition “ai” always hold at time steps “k= . . . , Tk−2, Tk−1, Tk”, and after a certain time step before Tk. That is, the step of the operator “?” (eventfully) cannot be set to infinity. Therefore, the “time step Tk” is set as the last step in the process, and thereafter, the process is not performed, but the target is achieved. The state vectors Xc, Xe, and Xw of each of the observation device 2, the end effector of the controlled device 4, and the workpiece 20 are also extended in such a way as to include time steps. That is, the state vectors of the time steps k are expressed as Xc,k, Xe, k, and Xw,k. Further, in order to represent whether the proposition is satisfied by a value of “0” or “1”, the imaged location Pi and the logical variable θi,k at the time step k having a value of “0” or “1” are introduced. In a case where the value of the proposition “ai,k” in the state vector Xc,k of the observation device 2 is expressed as “Xc,k[ai,k]”, that the proposition “ai,k” holds at the time step k means that the state vector Xc,k of the observation device 2 is included in the imageable region Hi. Therefore, the logical variable θi,k can be expressed as, for example, the following Expression (1).

$$\begin{matrix}[ Math . 1 ] & \\ {θ}_{i , k} = {X}_{c , k} [ {a}_{i , k} ] = 1 {¥X}_{c , k} {EH}_{i , k} & ( 1 )\end{matrix}$$

“E” is a symbol representing an element. For example, that “a is an element of the set A” is expressed as “a E A”.

Hi,k in Expression (1) represents the imageable region Hi as a region at the time step k. From Expression (1), when the value of the logical variable θi,k is 1, the proposition “ai,k” holds.

Similarly, the proposition “bi” that “the workpiece 20 is within the range of the appropriate region Gi” illustrated in FIG. 7B is extended to a proposition of a form including the time step k. The logical variable ηi,k at the time step k is introduced. That the proposition “bi,k” holds at the time step k is equivalent to that the state vector Xw,k of the workpiece 20 is included in the appropriate range Gi. Therefore, the logical variable ηi,k can be expressed as, for example, the following expression (2).

$$\begin{matrix}[ Math . 2 ] & \\ {η}_{ik} = {X}_{w , k} [ {b}_{i , k} ] = 1 {¥X}_{w , k} {EG}_{i , k} & ( 2 )\end{matrix}$$

Gi,k in Expression (2) represents the appropriate region Gi as a region at the time step k. From Expression (2), when the value of the logical variable ηi,k is 1, the proposition “bi,k” holds.

Next, changing the positions and the postures of the observation device 2 and the end effector by controlling the controlled device 4, that is, the robot arm is expressed by introducing a concept of a time step and a logical variable. In the case of the configuration illustrated in FIGS. 5 to 7 in the example embodiment of the present disclosure, the observation device 2 and the end effector change the position and the posture by the same arm (controlled device 4). That is, the change in the position and the posture of the observation device 2 and the change in the position and the posture of the end effector are executed by one controlled device 4. Therefore, the position and the posture of the observation device 2 and the position and the posture of the end effector cannot be brought close to the target values independently of each other. In the following description, it is assumed that any state vector (that is, any of the position and the posture of the observation device 2 and the position and the posture of the end effector is selected) is preferentially brought close to the target value. At the time step k, preferentially moving the state vector Xc,k of the observation device 2 is represented by a logical variable δc,k having a value of 0 or 1. For example, when the value of the logical variable δc,k is 0, the state vector Xe, k of the end effector is controlled to approach the control target, and when the value of the logical variable δc,k is 1, the state vector Xc,k of the observation device 2 is controlled to approach the control target.

Next, changing the position and the posture of the workpiece 20 by moving the end effector will be described. For example, it is considered that in a case where the distance between the end effector and the workpiece 20 is equal to or less than a predetermined distance, the workpiece 20 is gripped by the end effector, and the position and the posture of the workpiece 20 are changed to target values. This can be expressed using a logical variable δw,k having a value of 0 or 1 indicating whether the controlled device 4 can control the position and the posture of the workpiece 20. For example, in a case where the value of the logical variable δw,k is 0, the workpiece 20 is not gripped by the end effector, and the position and the posture are not changed. For example, in a case where the value of the logical variable δw,k is 1, the workpiece 20 is gripped by the end effector, and the position and the posture are changed.

By using the relation of Expressions (1) and (2), the order of each proposition can be expressed as a constraint condition. First, the constraint condition for the proposition “ai” to hold after the proposition “bi” holds, that is, the constraint condition for satisfying “when the state vector Xw,k of the workpiece 20 enters the appropriate region Gi (proposition “bi,k” holds) at all times (constantly), the state vector Xc,k of the observation device 2 can be moved” can be expressed, for example, by the following Expressions (3) to (5) using negative “!”, logical inclusion “¥”, and logical product “#”, which are logical operators, and next “&” and always “@”, which are temporal logical operators.

$$\begin{matrix}[ Math . 3 ] & \\ @ ( {δ}_{w , k} \# ! \& {δ}_{w , k} ¥ \& {η}_{i , k} ) & ( 3 )\end{matrix}$$

$$\begin{matrix}[ Math . 4 ] & \\ @ ( {δ}_{c , k} \# ! \& {δ}_{c , k} ¥ \& {θ}_{i , k} ) & ( 4 )\end{matrix}$$

$$\begin{matrix}[ Math . 5 ] & \\ @ ( ! {θ}_{i , k} {\#η}_{i , k} ¥ \& {δ}_{c , k} ) & ( 5 )\end{matrix}$$

Expression (3) is for a case where the value of the logical variable δw,k indicating that the position and the posture of the workpiece 20 are changed is 1 at a certain time step k and 0 at the next time step, that is, a case where the logical variable ηi,k at the next step is 1 when the change in the position and the posture of the workpiece 20 is completed, and represents that the proposition “bi” holds.

Expression (4) is for a case where the value of the logical variable δc,k indicating that the position and the posture of the observation device 2 are changed is 1 at a certain time step k and 0 at the next time step, that is, a case where the logical variable θi,k at the next step is 1 when the change in the position and the posture of the observation device 2 is completed, and represents that the proposition “ai” holds.

Expression (5) represents that, in a case where the proposition “ai,k” does not hold and the proposition “bi,k” holds at a certain time step k, the value of the logical variable δc,k that changes the position and the posture of the state vector Xc,k of the observation device 2 at the next step is 1 (true). Expression (5) represents that, in a case where the proposition “ai,k” holds or the proposition “bi,k” does not hold at a certain time step k, the value of the logical variable δc,k that changes the position and the posture of the state vector Xc,k of the observation device 2 at the next step is 0 (false). The constraint conditions expressed by Expressions (3) to (5) are examples, and the constraint conditions are not limited to Expression (3) to (5). As described above, in the example of the target logic expression including the constraint condition, (?ai)#(@!h) and Expressions (3) to (5) simultaneously hold. Hereinafter, this constraint condition is referred to as (D.

The abstraction model representing dynamics (also referred to as temporal change or time evolution) of the abstraction state illustrated in FIG. 6A/B or 7A/B can be expressed as, for example, the following Expression (6) by using a state vector and a logical variable in consideration of the above-described time step.

$$\begin{matrix}[ Math . 6 ] & \\ ( \begin{matrix}{X}_{c , k} \\ {X}_{w , k}\end{matrix} ) = I ( \begin{matrix}{X}_{c , k - 1} \\ {X}_{w , k - 1}\end{matrix} ) + ( \begin{matrix}{δ}_{c , k} \\ 0\end{matrix} ) {u}_{k} + ( \begin{matrix}0 \\ {δ}_{w , k}\end{matrix} ) {v}_{k} & ( 6 )\end{matrix}$$

In Expression (6), k represents a time step (an integer of k≥1), and k−1 represents a step immediately before the time step k. Therefore, Expression (6) represents a relation between the state vector Xc,k of the observation device 2 and the state vector Xw,k of the workpiece 20 at the time step k and the state vector Xc,k−1 of the observation device 2 and the state vector Xw,k−1 of the workpiece 20 at the time step k−1, that is, dynamics. In Expression (6), uk and vk are vectors related to control inputs when the observation device 2 and the workpiece 20 are controlled, respectively. It is desirable that uk and vk are vectors indicating a change amount per time step. For example, when the control input is a position, uk and vk are vectors indicating velocity. For example, in a case where the control input is a position angle, uk and vk are vectors indicating angular velocity. “I” represents a unit matrix. “0” represents a zero matrix. In Expression (6), δc,k and δw,k are logical variables indicating the presence or absence of control of the observation device 2 and the workpiece 20, and take values of 0 or 1. That is, Expression (6) represents dynamics including discrete (logical) variables in addition to continuous variables. Therefore, the system expressed by Expression (6) is generally called a hybrid system. In the example embodiment of the present disclosure, in the configuration illustrated in FIGS. 5 to 7, since the change in the position and the posture of the observation device 2 and the end effector is executed by one controlled device 4, the control inputs uk and vk may be the same variable. That is, Expression (6) can be expressed as:

$$\begin{matrix}[ Math . 7 ] & \\ ( \begin{matrix}{X}_{c , k} \\ {X}_{w , k}\end{matrix} ) = I ( \begin{matrix}{X}_{c , k - 1} \\ {X}_{w , k - 1}\end{matrix} ) + ( \begin{matrix}{δ}_{c , k} \\ {δ}_{w , k}\end{matrix} ) {u}_{k} & ( 7 )\end{matrix}$$

The control of each of the observation device 2 and the workpiece 20 may be executed not by one control device 6 but by a plurality of control devices 6. Therefore, Expression (6) related to the plurality of control devices 6 is more general. In the following description, Expression (7) related to one control device 6 will be used. However, the formulation of the abstraction model is not limited to Expression (6) or Expression (7). For example, in a case where there is a plurality of workpieces, the number of dimensions of the independent state vectors Xw,k in Expressions (6) and (7) increases by that amount.

Next, a more specific process in which the planning device 10 acquires and sets the abstraction state in step S104 described above and reflects the abstraction state in the abstraction model will be described. The planning device 10 acquires, as the abstraction state, at least the current values of the state vector Xc,k and the state vector Xw,k illustrated in Expression (6). The abstraction state is desirably a value of both the positions and the postures of the observation device 2 and the workpiece 20. In the configuration in which the observation device 2 exemplified here is mounted on the controlled device 4, the position and the posture of the observation device 2 can be calculated based on values managed by the control device 6 that controls the controlled device 4. In general, the control device 6 monitors a state (preferably, angle information) of a movable unit (actuator) of the controlled device 4. Therefore, the control device 6 can acquire the value. The relation between the angle information indicating the state of the movable unit and the state vector of the observation device 2 is determined by a configuration, preferably a geometric relation. The geometric relation is a translation and rotation relation between the reference point of the state of the controlled device 4 and the reference point of the state of the observation device 2. Specific examples of the translation and rotation relation include a vector representing translation and a rotation matrix representing rotation. That is, the translation and rotation relation indicates where the observation device 2 is installed in the controlled device 4. When the translation and rotation relation is given based on the configuration, the control device 6 can calculate the state vector of the observation device 2 from the angle information indicating the state of the movable unit. This calculation means may use the general means described above, and is not limited to a specific means. As described above, the position and the posture of the workpiece 20 may be acquired by the control system 100 according to the example embodiment of the present disclosure or may be acquired by a means other than the control system 100. In general, an object recognition method can be used as a method of the plan generation unit 13 acquiring the position and the posture of the workpiece 20. However, for example, the user may instruct the position and the posture of the workpiece 20 via the input device 1. The object recognition here is not applied to the time step k, that is, the “entire path”. Step S104 is a processing step of “acquiring and reflecting (substituting in an expression) the current state”. Therefore, the object recognition is not reflected at the present time, that is, after the initial value of the time step k. That is, the object recognition is performed before processing and operation to be described later, and the subsequent state of the object is not continuously acquired.

As described above, when the value of the state vector at a certain time step is known, the values of the state vectors at the subsequent time steps can be sequentially calculated by the abstraction model exemplified in Expression (6). In the abstraction model exemplified in Expression (6), it is desirable that a value of a state vector at the time of starting the objective task is given, and a change in the state vector until the objective task is completed can be calculated. The value of the state vector at the time of starting the objective task is given by the above-described object recognition or input by the user. All the states in the subsequent time steps are given by calculation (for example, simulation or the like) based on an abstraction model (dynamics).

Next, a more specific process of determining whether the operation determination unit 11 operates the workpiece 20 or another object in step S105 described above will be described.

In the case of the environment illustrated in FIG. 7A/B, whether to operate the workpiece 20 in the process of step S105 coincides with the authenticity of the above-described proposition “bi: the position and the posture of the workpiece 20 are within the range of the appropriate region Gi”. In other words, according to Expression (2), when the value of the logical variable ηi,k is 0, the workpiece 20 is operated because the proposition “bi” is not satisfied, and when the value of the logical variable ηi,k is 1, the workpiece 20 is not operated because the proposition “bi” is satisfied. Therefore, the process (step S105) of the operation determination unit 11 includes outputting the value of the logical variable ηi,k. The specific example of the environment illustrated in FIG. 7A/B is an example of a case where there is no object other than the workpiece 20 in the environment, and Expression (2) holds opposite. That is, if that “Xw,k enters appropriate region Gi” indicated on the right side of Expression (2) is satisfied, the proposition “bi,k” on the left side of Expression (2) is satisfied. That is, the logical variable is 1 (from the definition). Therefore, the value of the logical variable ηi,k at the time step k can be determined by determining the right side of Expression (2). That is, the value of the logical variable ηi,k can be determined based on the relation between the position vector Xw,k of the workpiece 20 and the appropriate region Gi at the time step k. For example, when it is determined that “the angle formed by the normal vector of the imaged location Pi and the appropriate region Gi is equal to or less than a certain threshold value”, the operation determination unit 11 can determine the value of the logical variable ηi,k to be 1. When determining that “the angle formed by the normal vector of the imaged location Pi and the appropriate region Gi exceeds the certain threshold value”, the operation determination unit 11 can determine the value of the logical variable ηi,k to be 0. When the state of the workpiece 20 is calculated by the object recognition, the normal vector of the imaged location Pi can be calculated based on the information stored about the imaged location Pi (when the current position and the current posture of the workpiece 20 are known, the imaged location can be known.). As a result, the value of the logical variable can be determined by comparison (for example, comparison of angles formed by normal vectors) between the imaged location Pi and the appropriate region Gi. For this determination, common object recognition techniques may be uses in the first step of initiating the objective task, and the specific means may not be used. When the state of the workpiece 20 is calculated by the object recognition, the normal vector of the imaged location Pi can be calculated based on the stored information about the imaged location P (when the current position and the current posture of the workpiece are known, the imaged location can be known.). As a result, as described above, the value of the logical variable can be determined by comparison with the appropriate region (for example, comparison of angles formed by normal vectors). In the subsequent time steps, the values sequentially calculated by the abstraction model exemplified in Expression (6) can be referred to.

Next, a more specific process in which the observation determination unit 12 determines whether the observation device 2 enters a region where the observation device 2 is allowed to observe the workpiece 20 in step S106 described above will be described. In the example of the environment illustrated in FIG. 7A/B, whether the observation device 2 enters a region where the observation device 2 of the present processing is allowed to observe the workpiece 20 coincides with the authenticity of the above-described proposition “ai: The state vector Xc,k of the observation device 2 is included in the imageable region Hi”. In other words, according to Expression (1), when the value of the logical variable θi,k is 0, the workpiece 20 cannot be observed because the proposition “ai” is not satisfied, and when the value of the logical variable ηi,k is 1, the workpiece 20 can be observed because the proposition “ai” is satisfied. Therefore, the process (step S106) of the observation determination unit 12 includes outputting the value of the logical variable θi,k. The specific example of the environment illustrated in FIG. 7A/B is an example of a case where there is no object other than the workpiece 20 in the environment, that is, a case where Xc enters the imageable region Hi, and the expression (1) holds opposite (that is, the logical variable is 1.). Therefore, the value of the logical variable θi,k at the time step k can be determined by determining the right side of Expression (1). That is, the value of the logical variable θi,k can be determined based on the relation between the position vector Xc,k of the observation device 2 and the imageable region Hi at the time step k. As described above, the observation determination unit 12 can calculate the value of the position vector Xc,k of the observation device 2 at the time step k based on the state information about the controlled device 4. The observation determination unit 12 can obtain the imageable region Hi based on the task information input by the input device 1, the accumulated data of FIG. 2 (preferably, the observation device information I3 and the object model information I7) stored in the storage device 3, and the state vector Xw,k of the workpiece 20 at the time step k. In the acquisition of the value of the state vector Xw,k of the workpiece 20, object recognition or the like can be used as described above in the first step of starting the objective task, and the means may be any means. In the subsequent time steps, values sequentially calculated by the abstraction model exemplified in Expression (6) can be acquired.

Next, a more specific process in which the plan generation unit 13 generates and outputs an operation plan that satisfies the target logic expression and the abstraction model in step S107 described above will be described. As described above, the target logic expression is obtained by collecting expressions (3), (4), and (5) indicating the constraint conditions in addition to the proposition (?ai)#(@!h) in an example when the objective task is set as the imaging task. In the following description, this collected target logic expression is expressed as D. In addition, the abstraction model is expressed by Expression (6) (expressed as “E”). The operation plan that satisfies the target logic expression F and the abstraction model (Expression (6)) may be obtained in such a way that the values of the state vector Xc,k, the state vector Xw,k, the logical variable δc,k, and the logical variable δw,k at each time step satisfy Expressions (3), (4), and (5) representing constraint conditions. As the values of the logical variables ηi,k and θi,k and in the expressions (3), (4), and (5) representing the constraint conditions, the values of the logical variables ηi,k and θi,k output by the operation determination unit 11 and the observation determination unit 12 may be used. The values of the state vector and the logical variable at each time step (that is, the time series operation plan for each step) are obtained, for example, by minimizing the sum of squares of the norm of the control input uk in the following Expression (8).

$$\begin{matrix}[ Math . 8 ] & \\ {arg min}_{u} ( {\sum }_{k = 0}^{{T}_{k}} ( {‖ {u}_{k} ‖}^{2} ) ) s . t . Σ {\#ϕ}_{k} & ( 8 )\end{matrix}$$

In Expression (8), Ok is an expression in which Expressions (3), (4), and (5) indicating the constraint conditions are put together. Expression (8) represents an optimization problem using the target logic expression as a constraint condition and the sum of squares of the norm of the control input uk as an evaluation function. Specifically, since a logical variable is included, it is referred to as a mixed integer optimization problem or a mixed integer programming problem. A solution to the mixed integer programming problem is referred to as a mixed integer programming (MIP).

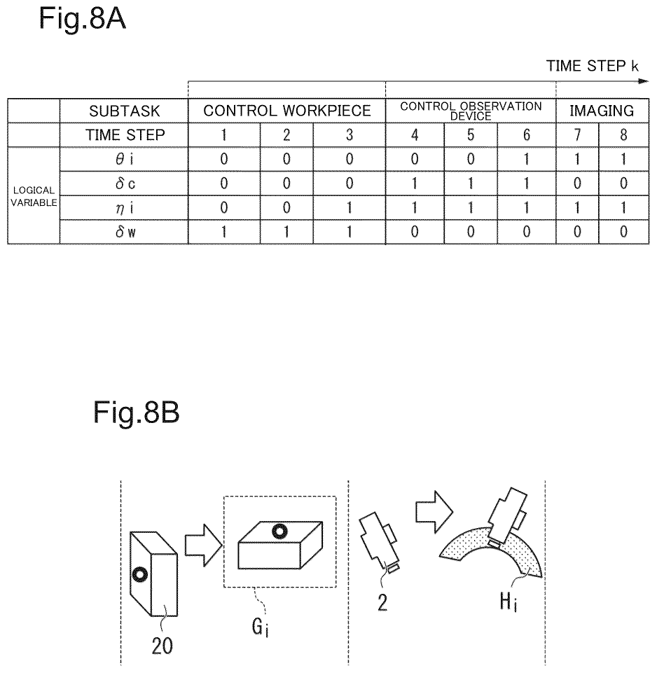

FIG. 8 A/B is a diagram schematically illustrating an example of a change in a logical variable assuming a result of solving an optimization problem in an example embodiment of the present disclosure and an operation related to the example of the change. FIG. 8 A/B illustrates an example of the operation plan. In FIG. 8A, the lateral direction is a change (k=1, 2, 8) in the time step k, and values of θi,k representing observation determination, δc,k representing control of the observation device, ηi,k representing operation determination, and δw,k representing control of the workpiece are shown at each time step for each logical variable described in the upper part. The interval, the total number, and the value change of the time step are examples. In FIG. 8B, the operation (control) related to the change in the value of each logical variable is separately described. For example, in a case where the value of the logical variable δw,k (described as δw in FIG. 8A) representing the control of the workpiece is 1, the position and the posture of the workpiece 20 are being changed, and it indicates that ηi,k (described as ηi in FIG. 8A) indicating the operation determination is changed from 0 to 1 at the time step k=3, that is, the workpiece 20 is included in the appropriate region Gi. Since the value of the control δw,k of the workpiece is 0 at the time step k=4, it indicates that the control δw,k of the workpiece has been completed. Therefore, FIG. 8 A/B illustrates that the position and the posture of the workpiece 20 are changed in such a way as to enter the appropriate region Gi during the time steps k=1, 2, and 3, and FIG. 8 A/B describes “control the workpiece”. Next, at the time step k=4, the value of the logical variable δc,k (described as δc in FIG. 8A) representing the control of the observation device 2 changes from 0 to 1. This change indicates that the control of the observation device 2 is started after the control of the workpiece 20 is completed. Thereafter, since 1 continues as the value of the logical variable δc,k until the time step k=6, the control of the workpiece 20 is continued. Since the value is 0 at time step k=7, the control of the observation device 2 is completed. At the time step k=6, the value of θi,k representing the observation determination changes from 0 to 1, indicating that the observation device 2 is included in the imageable region Hi. Therefore, during the time steps k=4, 5, and 6, the observation device 2 changes the position and the posture in such a way as to enter the imageable region Hi, and FIG. 8 A/B describes “control the observation device”. Since the value of θi,k (described as θi in FIG. 8A) representing the observation determination is 1 at the time step k=7, it is indicated that the proposition “ai” is satisfied, that is, that the imaging task is achievable, and in FIG. 8 A/B, it is described as “imageable”.

The relation between the change in the logical variable and the subtask will be described. The subtask is a task defined in units of operating the controlled device 4, the task being combined to complete the objective task. The subtask is desirably controlled for each unit of the subtask. A subtask may be associated with a logical variable. For example, FIG. 8 A/B illustrates an example in which the control is switched based on the value of the logical variable δw,k and the value of the logical variable δc,k. Therefore, a unit in which the control is switched may be defined as a subtask. That is, in the example of FIG. 8 A/B, the subtask can be divided in such a way that the period in which the logical variable δw,k is 1 is a “subtask that controls the workpiece”, the period in which the logical variable δc,k is 1 is a “subtask that controls the observation device”, and the period in which the logical variable θi,k is 1 is a “subtask that images the workpiece”. Such a relation between the change in the logical variable and the subtask and the control may be stored as the subtask information I5 of the storage device 3. The above division of subtasks is an example and is not limited to the above.

Finally, a specific process in which the control device 6 controls the controlled device 4 in step S108 described above will be described. The control device 6 outputs a control signal generated based on the operation plan to the controlled device 4. The control device 6 desirably outputs a control signal to the controlled device 4 in units of subtasks. For example, the operation plan may include, in addition to the information indicating the subtask, a time series target value or the like associated with the time step. The control device 6 can generate a control signal in units of subtasks according to the operation plan. The control method by the control device 6 may use an existing means. However, the means is not limited. For example, the control method by the control device 6 may include control such as feeding back a position, a speed, and the like and following a time series target value.

An order relation between the subtasks will be described. As described above, the target logic expression and the constraint condition are already reflected in the change in the logical variable for each time step calculated as a result of solving the optimization problem of Expression (8). That is, the change in the logical variable satisfies the constraint condition about the order. Therefore, the subtasks defined based on the change in the logical variable also satisfy the order constraint. As described above, it is a feature of the present disclosure that the order constraint of the subtasks, that is, of the control is automatically satisfied by defining the constraint condition in the form of a logic expression (proposition) even if the order related constraint is not identified in advance for each subtask. However, the method, means, and procedure of reflecting the constraint condition in the logic expression are not limited to a specific means and procedure. For example, the constraint condition may be designated as the constraint condition information I2 stored in the storage device 3, may be designated as the subtask information I5, or may be additionally designated by the user via the input device 1.

Although the operation of the control system 100 according to the first example embodiment is described above as an example when the objective task is an imaging task, the above-described formulation and calculation are merely examples, and the present invention is not limited thereto.

### Another Operation Example of First Example Embodiment

Next, another operation example of the first example embodiment will be described. Similarly, the objective task is an imaging task, and a case where an environment different from the environment illustrated in FIGS. 5 to 7 is taken as an example is indicated. The configuration and operation are similar.

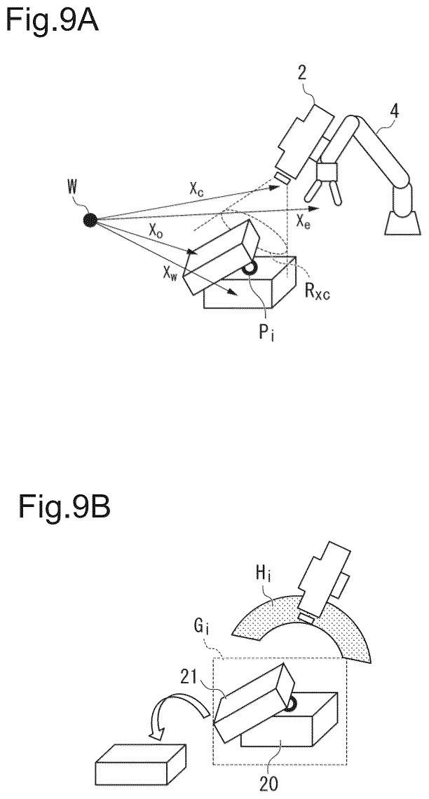

FIG. 9A/B is a diagram illustrating an example of another abstraction state in a case where the objective task is the imaging task in the first example embodiment of the present disclosure. FIG. 9A/B illustrates an abstraction state in the imaging task related to that in FIG. 7A/B. However, unlike FIG. 7A/B, FIG. 9A/B illustrates a state in which an obstacle 21 overlaps the upper portion of the workpiece 20. FIG. 9A/B is an example of a case where an object other than the workpiece 20 exists in the environment. The number, arrangement, and the like of the obstacles are not limited to those illustrated in FIG. 9A/B. This example is an example of a case where the state vector Xw of the workpiece 20 and the state vector Xo of the obstacle 21 are acquired in the operation (step S104) in which the planning device 10 acquires and sets the abstraction state and reflects the state in the abstraction model. Acquisition of state information such as a workpiece and an obstacle in the environment in this manner depends on a means for acquiring the environment and the state information, for example, an object recognition means, but this means may be any means. A case is considered in which identification and classification of whether the acquired state information is the workpiece 20 or the obstacle 21 have been made.

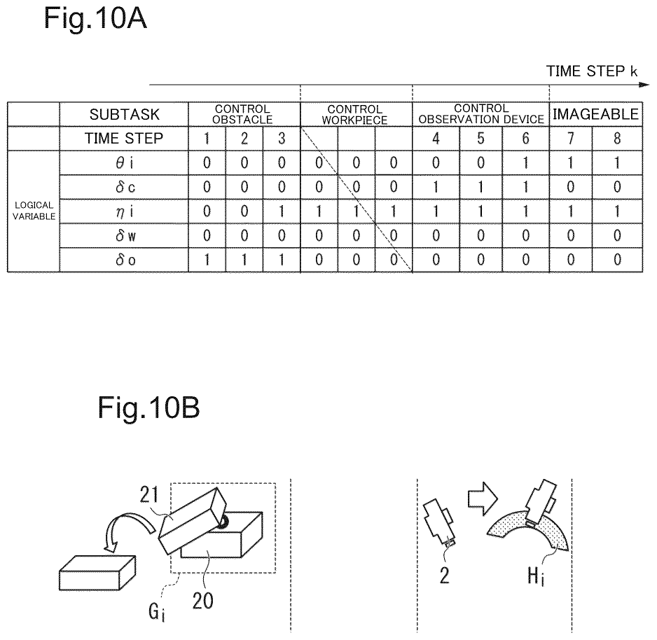

Also in this operation example, the target logic expression and Expressions (3), (4), and (5) representing the constraint condition are not changed. The present operation will be described with respect to an example of the operation plan (specifically, an operation plan illustrated in FIG. 10A/B to be described later) without adding an expression. Hereinafter, a case where the condition of which object is controlled first is not applied will be described, but such a condition may be included as a constraint, and may be appropriately set according to the environment, task, or object. However, the abstraction model expressed by Expression (6) or (7) is changed. As in the workpiece 20, it is assumed that the obstacle 21 is grasped by the end effector in a case where the distance between the controlled device 4, that is, the end effector and the obstacle 21 is equal to or less than a predetermined distance, and the position and the posture can be changed to target values. It is assumed that when the distance between the end effector and the obstacle 21 exceeds a certain predetermined distance, the end effector does not grasp the obstacle and the position and the posture are not changed. This can be expressed as in the workpiece 20 by newly adding a logical variable δo,k having a value of 0 or 1 indicating whether the controlled device 4 can control the position and the posture of the obstacle 21. That is, when the value of the logical variable δo,k is 0, the obstacle 21 is not grasped by the end effector, and the position and the posture are not changed. On the other hand, when the value of the logical variable δo,k is 1, the obstacle 21 is grasped by the end effector, and the position and the posture are changed. In a case where the state vector and the logical variable are newly added in this way, the abstraction model can be expressed as, for example, the following Expression (9).

$$\begin{matrix}[ Math . 9 ] & \\ ( \begin{matrix}\begin{matrix}{X}_{c , k} \\ {X}_{w , k}\end{matrix} \\ {X}_{o , k}\end{matrix} ) = I ( \begin{matrix}\begin{matrix}{X}_{c , k - 1} \\ {X}_{w , k - 1}\end{matrix} \\ {X}_{o , k - 1}\end{matrix} ) + ( \begin{matrix}\begin{matrix}{δ}_{c , k} \\ {δ}_{w , k}\end{matrix} \\ {δ}_{o , k}\end{matrix} ) {u}_{k} & ( 9 )\end{matrix}$$

Expression (9) is an expression expanded by introducing the logical variable δo,k into Expression (7) representing the abstraction model, and it is possible to adopt an expression expanded by introducing the logical variable δo,k into Expression (6), but the formulation of Expression (9) is not limited thereto. Expression (9) is similar to Expression (7) except that a state vector Xo and a logical variable δo for the obstacle 21 are added.

As described above, the plan generation unit 13 can generate an optimal operation plan in this environment to output the generated operation plan only by replacing the abstraction model “X” in the optimization problem expressed by Expression (8) with Expression (9). However, it is necessary to add constraint conditions for the logical variable δw,k and the logical variable δo,k that determine the control of the workpiece 20 and the obstacle 21. This is because, in the case of the configuration illustrated in FIG. 9A/B, both the workpiece 20 and the obstacle 21 cannot be controlled at the same time step. That is, the values of the logical variables cannot be simultaneously true (set to 1). For this reason, for example, the following Expression (10) is required to be added as the constraint condition.

$$\begin{matrix}[ Math . 10 ] & \\ {\sum }_{j = 1}^{n} {δ}_{j , k} \leq 1 & ( 10 )\end{matrix}$$

j (an integer of 1 or more) in Expression (10) represents a subject to be controlled by the controlled device 4, that is, any of the workpiece 20, the obstacle 21, or the observation device 2 in the configuration of FIG. 9A/B. That is, j in Expression (10) includes all that is expressed by the logical variable S. For example, j=1 represents the workpiece 20, and j=2 represents the obstacle 21. That is, Expression (10) means a constraint condition that n objects in the environment cannot be simultaneously controlled. This constraint condition may not be necessary depending on a device configuration or an environment. For example, in a case where there is a plurality of controlled devices 4, that is, a plurality of robot arms, and a plurality of end effectors is mounted, Expression (10) is unnecessary.

FIG. 10A/B is a diagram schematically illustrating an example of a change in each logical variable and an operation related to the example of the change when the constraint condition of Expression (10) is added to solve the optimization problem in the example embodiment of the present disclosure. FIG. 10A/B illustrates an example of the operation plan. The logical variable illustrated in FIG. 10A is different from the logical variable illustrated in FIG. 8 A in that the logical variable δo (described as δo in FIG. 10A) for the obstacle 21 is added. In FIG. 10A, in a case where the value of the logical variable δo is 1 at time step k=1 to 3, it is indicated that the obstacle 21 is first controlled, that is, the position and the posture of the obstacle 21 are changed. The subtask related to this control is described as “control obstacle” in FIG. 10A. Although the target value in the case of changing the position and the posture of the obstacle 21 is not designated, the target value can be appropriately determined. For example, by designating a position away from another object by a certain specified amount based on state information about another object in the work space, the another object can be moved to a region away from the workpiece 20 as illustrated in FIG. 10B. Such a target value may be stored as, for example, constraint condition information I5 of the storage device 3.

Next, that the value of the operation determination ηi,k, which is a logical variable, is 1 at time step k=3 in FIG. 10A will be described. The determination of the operation determination ηi,k (described as the operation determination ηi in FIG. 10A) is expressed by Expression (2). However, in the environment illustrated in FIGS. 9 and 10, Expression (2) does not hold opposite. That is, even when the workpiece 20 is included in the appropriate region Gi, the operation determination ηi,k is not necessarily 1 (true). The reason is that, as is clear from FIGS. 9 and 10, even when the position and the posture of the workpiece 20 are appropriate (that is, even when the state information about the workpiece 20 can be acquired and the workpiece 20 is included in the appropriate region Gi), there is an influence (for example, the influence of the obstacle 21 such that the objective task is an imaging task, and for the relation in position and posture between the imaged location Pi and the imaging device 2 (an example of an observation device), even when t the imaged location Pi is included in the range where the imaging device 2 can capture an image, when the obstacle 21 covers the imaged location Pi of the workpiece 20, the imaging device 2 cannot actually capture an image of the imaged location Pi) of another object such as the obstacle 21. Therefore, the determination process of the operation determination ηi,k performed by the operation determination unit 11 is required to cope with such an environment. The operation determination unit 11 can cope with the determination of the operation determination ηi,k in such an environment by using the means of image processing or object recognition. For example, the operation determination unit 11 may identify each of the obstacle 21 and the workpiece 20 by using the means of image processing or object recognition, set the determination of the operation determination ηi,k to 1 (true) in a case where the obstacle 21 exists outside the appropriate region Gi, and set the determination of the operation determination ηi,k to false in a case where the obstacle 21 exists within the appropriate region Gi. A method of identifying each of the obstacle 21 and the workpiece 20 is not limited to a method using the means of image processing or object recognition. For example, the method of identifying each of the obstacle 21 and the workpiece 20 may be a method of the user giving identification information via the input device 1. The process of identifying each of the obstacle 21 and the workpiece 20 is performed at a timing (for example, at the beginning of the process) before the operation plan. Therefore, the object is not recognized and the determination by the user is not made at the time step k=3, but the object is identified in the initial state (time step k=1).

In the example illustrated in FIG. 10A, the value of the operation determination ηi,k is 1 at the time step k=3. In this case, the operation of controlling the workpiece 20 is unnecessary. In the upper part of FIG. 10A, three columns of the item “control workpiece” are described for the sake of explanation, but since the value of the operation determination ηi,k is 1 and the value of the workpiece control δw,k, which is a logical variable representing the control of the workpiece 20, is 0 at any time step, it is unnecessary to control the workpiece 20 from the result of the optimization calculation. Since the condition for controlling the observation device 2 is satisfied, the value of the control δc,k of the observation device 2 is 1 at time step k=4, and the control of the observation device 2 is started. Since the operation at the time step k=4 and the subsequent steps is similar to the operation illustrated in FIG. 8A/B, description thereof is omitted.

Although the operation in a case where the environment is different is described above, the control system 100 according to the example embodiment of the present disclosure has a feature in which the objective task can be achieved without an additional configuration or additional processing even in a case where the environment is different. For convenience of description, the case of only the workpiece 20 and the case where there is another object are described. In the first example embodiment, since the state information about the work space is input and the processing proceeds based on the constraint conditions and information when executing the task, the condition for determining “environment” is not input. On the other hand, another operation example of the first example embodiment indicates that “it is necessary to cope with the environment”. This indicates that identification of another object (obstacle) and its state information are necessary, and it indicates that the operation can cope with the environment because there is a means for identifying another object (obstacle). That is, even when the relation between the target object (workpiece 20) and the observation device 2 is not ideal, the control system 100 can provide an operation plan in which the control can be continued and the work can be performed.

### (Advantages)

As a result, the control system 100 can achieve precise control of the controlled device according to the control system.

### <Second Example Embodiment

### (Device Configuration)

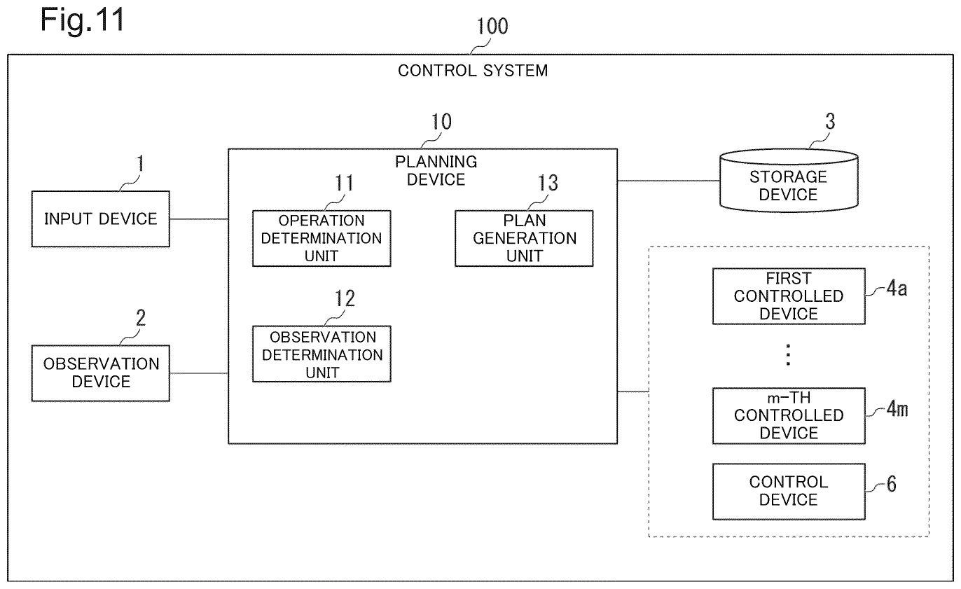

FIG. 11 is a diagram illustrating an example of a configuration of the control system 100 according to the second example embodiment of the present disclosure. The control system 100 illustrated in FIG. 11 is different from the control system 100 according to the first example embodiment in that the controlled device 4 includes a plurality of control devices from a first controlled device 4a to a m-th controlled device 4m. The number of controlled devices is at least two or more, and is not limited. The other configurations are the same as those of the first example embodiment, and thus the description thereof will be omitted below. Note that FIG. 11 illustrates a configuration in which the control device 6 similar to that in the first example embodiment is provided for a plurality of controlled devices, but the number of control devices 6 and the relation with the controlled devices 4 are not limited to this configuration.

### <Operation>

As illustrated in FIG. 11, since the second example embodiment is different from the first example embodiment in an abstraction model and constraint conditions in that it includes a plurality of controlled devices 4a to 4m. For example, in the first example embodiment, the abstraction model is re-described in Expression (7) from Expression (6), but in the second example embodiment of the present disclosure, the control inputs u, v, related to the respective controlled devices 4a to 4m can be individually and independently set as in Expression (7). Specifically, in a case where there are two controlled devices 4a and 4b, the control inputs u and v of Expression (7) can be made to be related to the respective controlled devices. Therefore, even at the same time step, the controlled device 4a and the controlled device 4b can be individually and independently controlled. This affects the constraint conditions. Expression (10) in the first example embodiment is a constraint condition that only one object can be controlled in the same time step, that is, the sum of logical variables related to control is equal to or less than the number of controlled devices, but this constraint condition is relaxed. Specifically, in the second example embodiment of the present disclosure including m controlled devices, the constraint condition related to Expression (10) in the first example embodiment is expressed by the following Expression (11).

$$\begin{matrix}[ Math . 11 ] & \\ {\sum }_{j = 1}^{n} {δ}_{j , k} \leq m & ( 11 )\end{matrix}$$

Therefore, in Expression (11), the change in the logical variable related to the control is not exclusive, unlike Expression (10) of the first example embodiment. That is, in Expression (11), in a case where the value of one logical variable is 1, the values of the other logical variables are not 0 but can be 1. This means that when the number of time steps is the same, the control system 100 according to the second example embodiment can control more controlled devices 4 than the control system 100 according to the first example embodiment, and improvement in work efficiency such as reduction in work time can be expected.

However, Expression (11) is established only when the state change target object j is different for every controlled device 4. For example, Expression (11) holds in a case where the state is changed by different controlled devices as in the controlled device 4a for the observation device 2, the controlled device 4b for the workpiece 20, and the controlled device 4c for the obstacle 21 among the state change target objects j. This is because the controlled devices 4a to 4m controlled by the plurality of control devices 6a to 6 m cannot simultaneously target the same state change target object j. However, as in the above example, the number of the state change target objects j and the number m of the controlled devices 4 do not need to match, and the correspondence relation for changing the state can be determined in any manner. That is, the number of the state change target objects may be smaller than the number of the controlled devices, or conversely, the number of the controlled devices may be smaller than the number of the state change target objects, and the correspondence relation for changing the state is not limited. It is necessary to avoid interference (contact) between the controlled devices 4a to 4m. This can be added as a constraint condition, for example, in relation to the proposition “do not enter a region defined as an obstacle at any time (@!h)” described as the target logic expression of the first example embodiment. For example, another controlled device can be included in the region defined as an obstacle, or the x coordinate (X4a, X4b) of the end effector of each of the controlled device 4a and the controlled device 4b can be included as a coordinate constraint condition such as “X4a<X4b”. These are examples, and constraint conditions may be appropriately added according to the environment, the number of control devices and controlled devices, and the configurations of the control devices and controlled devices.

### (Advantages)

As a result, the control system 100 can achieve precise control of the controlled device according to the control system.

### <Third Example Embodiment

### (Device Configuration)

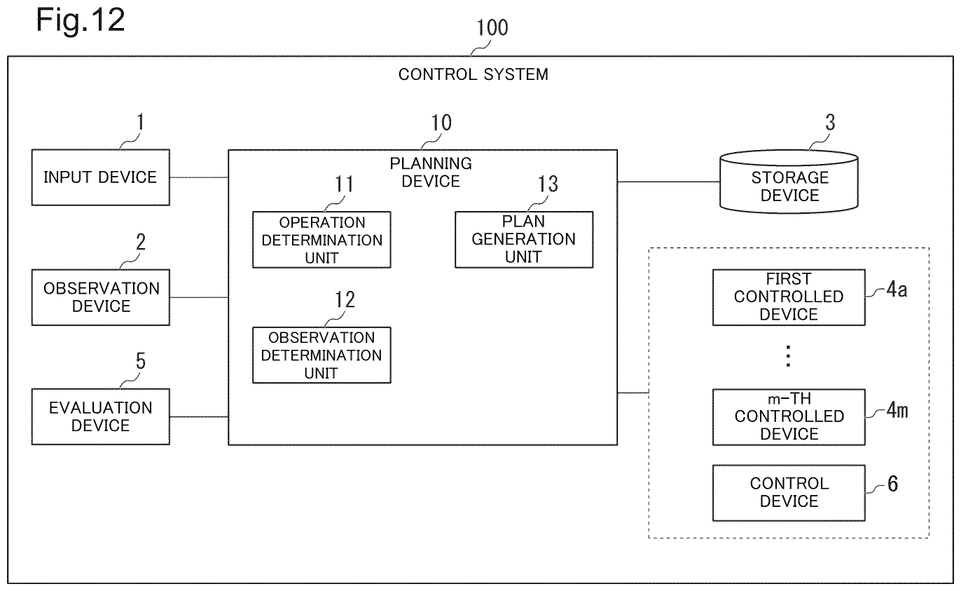

FIG. 12 is a diagram illustrating an example of a configuration of the control system 100 according to the third example embodiment of the present disclosure. A control system 100 illustrated in FIG. 12 has a configuration in which an evaluation device 5 is further added to the configuration of the control system 100 according to the second example embodiment. However, as for the number of controlled devices 4, the control system 100 according to the third example embodiment of the present disclosure may include a plurality of controlled devices 4a to 4m as in the second example embodiment, or may include a single controlled device 4 as in the first example embodiment.

### <Operation>

The evaluation device 5 evaluates a result of observation performed by the observation device 2 as an objective task. As a specific example, in a case where the objective task is an imaging task, the evaluation device 5 receives image information about the image captured by the observation device 2 to output an evaluation result. The evaluation result is, for example, whether the range designated as the objective task is imaged, whether the image is blurred, whether the luminance (exposure) is appropriate, or the like. The observation determination unit 12 can receive an evaluation result output by the evaluation device 5 as an input. For example, the observation determination unit 12 normally determines whether the observation device 2 enters a region that can be observed based on a calculation value for calculation of plan information, that is, before operation. The determination by the observation determination unit 12 is performed after the observation determination unit 12 actually operates. On the other hand, a method of switching before and after the operation of the observation determination unit 12 is considered. A general image processing technique can be used for the evaluation performed by the evaluation device 5. For the evaluation performed by the evaluation device 5, an evaluation result received as an input may be appropriately set using a technology of image processing according to an objective task or an environment.

A new effect by the evaluation device 5 according to the third example embodiment of the present disclosure will be described. In the first and second example embodiments, the observation determination unit 12 performs the determination process in step S106, for example, according to whether the observation device 2 enters a region where the observation device 2 is allowed to observe the workpiece 20. That is, the observation determination unit 12 performs the determination in step S106 based on the state vectors, positions, postures, shapes, and the like of the workpiece 20 and the observation device 2. This means that the observation determination unit 12 makes a determination based on the abstraction state without using the actual information acquired by the observation device 2. However, for the purpose of achieving the imaging task, determination based on actual information actually acquired by the observation device 2 is important. Therefore, in the third example embodiment of the present disclosure, the observation determination unit 12 performs the determination operation based on the output of the evaluation device 5, so that the objective task can be achieved even in a case where the determination based on the abstraction state is inappropriate. That is, the observation determination unit 12 of the third example embodiment has a function of performing the process of determining the authenticity of the proposition of imageable, using the actual information acquired by the observation device 2. For example, the observation determination unit 12 normally determines the authenticity of a proposition of imageable based on a calculation value for calculation of an operation plan, that is, before operation. However, this determination by the observation determination unit 12 is performed after the observation determination unit 12 actually operates. On the other hand, a method of switching before and after the operation of the observation determination unit 12 is considered. For example, in a case where the evaluation device 5 outputs an evaluation result that “the image is blurry (the contrast of the edge portion is low)”, the observation determination unit 12 can determine that the value of the logical variable θi,k is 0, that is, the proposition “bi” of imageable is false even in a case where the state vector of the observation device 2 is included in the observable region Hi. From the determination result, the control device 6 may use, for example, a function of changing the distance between the observation device 2 and the workpiece 20 by controlling the controlled device 4, an autofocus function, a visual feedback function, and the like in combination. The control method by the control device 6 is not limited to the control method based on the position and the posture of the observation device 2.

Furthermore, effects produced by the control system 100 according to the third example embodiment of the present disclosure including the evaluation device 5 and the plurality of controlled devices 4a to 4m will be described. As a result of the output by the evaluation device 5, in a case where the value of the logical variable θi,k is 0 (that is, in a case where the evaluation result is inappropriate), the control system 100 according to the third example embodiment is not limited to coping with only the control by the single controlled device 4. That is, the control system 100 according to the third example embodiment may include a plurality of controlled devices. For example, in a case where the evaluation device 5 outputs an evaluation result that “the luminance of the image is low (dark)” and the observation determination unit 12 outputs 0 as the value of the logical variable θi,k, the controlled device 4b may be used as an illumination device in addition to the controlled device 4a that changes the position and the posture of the observation device 2, and the controlled device 4b may be controlled to illuminate the workpiece 20. The operation of applying the illumination can be achieved, for example, by newly adding a logical variable for determining the control of the illumination device based on the output of the evaluation device 5. As described above, the third example embodiment of the present disclosure is characterized in that the values of the plurality of logical variables that determine the control of the plurality of controlled devices 4a to 4m can be changed based on the output of the evaluation device 5. In the above description, since the imaging task is taken as an example, the output of the evaluation device 5 has been exemplified as the evaluation result based on the image, but the present invention is not limited thereto. For example, in a task of reading a barcode attached to a workpiece, a reading device is a specific example of the evaluation device 5, and a reading result is an output example of the evaluation device 5.

### (Advantages)

As a result, the control system 100 can achieve precise control of the controlled device according to the control system.

### Application Example

Hereinafter, application examples based on the first to third example embodiments will be described.

### First Application Example

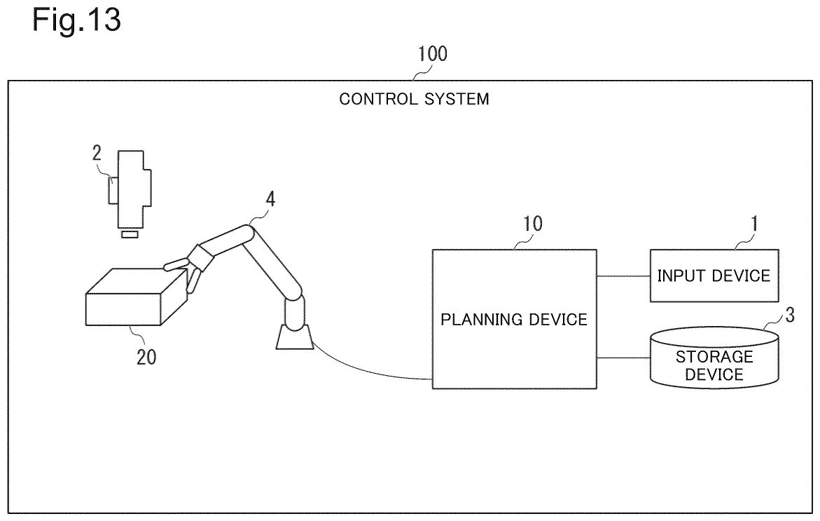

The first application example is an example in which the control system 100 according to the first example embodiment is applied to an objective task such as inspection, registration, and collation of workpieces performed at a manufacturing site, a distribution site, or the like with the observation device 2 as a dedicated sensor installed in a work space, and the controlled device 4 as an articulated robot arm. FIG. 13 is a diagram illustrating the first application example of the control system 100 according to the first example embodiment of the present disclosure. FIG. 13 illustrates a configuration example of the control system 100 as the present application example. Since other configurations are similar to those of the first example embodiment, the description thereof will be omitted.

In the first application example, examples of the dedicated sensor of the observation device 2 include an image acquisition means such as a camera, a barcode reader, a radio frequency identification (RFID) scanner, and a microscope camera (microscope). These dedicated sensors may be appropriately used according to the objective task. For example, in the case of applying to product management and traceability by registering and collating a surface pattern (object fingerprint) of a workpiece, a microscope camera may be used.

The first application example illustrates an example in which the observation device 2 is not provided in the controlled device 4, and the observation device 2 is fixed and installed at a predetermined position in a predetermined orientation. That is, in the first application example, the position and the posture of the observation device 2 are unchanged. On the other hand, the controlled device 4 includes a means capable of operating the workpiece 20, specifically, an end effector such as a robot hand. That is, the relation in relative position and in relative posture between the observation device 2 and the workpiece 20 can be changed by changing the position and the posture of the workpiece 20 by the controlled device 4. The operation of the control system 100 can be considered as in the control system 100 according to the first example embodiment.

An effect obtained by fixing the installation position and the installation direction of the observation device 2 as in the present application example will be described. Since the observation device 2 is not mounted on the controlled device 4, the control system 100 can increase the load capacity of the single robot when the controlled device 4 is particularly a robot arm. In general, in a robot arm, a load capacity excluding a weight of an end effector is defined based on a load capacity of a single robot or a weight of the end effector. Examples of the end effector include a robot hand. Therefore, when the observation device 2 is mounted in the vicinity of the end effector of the robot arm, the weight of the observation device 2 is added, and thus, there is a possibility that the load capacity decreases, that is, control for gripping a heavy workpiece or changing the position and the posture cannot be performed. Therefore, this possibility can be reduced by fixing and installing the observation device 2 at a predetermined position in a predetermined orientation other than those of the controlled device 4. In a case where the shape of the observation device 2 is complicated or large, and the observation device 2 moves in conjunction with the controlled device 4, the observation device 2 may come into contact with the surrounding obstacle 21. Of course, as described in the first example embodiment, for example, the plan generation unit 13 acquires the information about a shape of the observation device 2 from the observation device information 13 and sets the shape as the obstacle region, so that the planning device 10 can output the operation plan in which there is no contact according to the constraint condition “@!h” when the proposition “exist in the obstacle region” is “h”. However, since the observation device 2 moves, there is a possibility that the restriction of the operation range increases or the calculation load of the planning device 10 increases. On the other hand, with the configuration in which the observation device 2 is installed in the work space, the observation device 2 can be a static obstacle, so that this configuration has an effect of reducing this possibility.

As described above, the first application example in which the objective task such as inspection, registration, and collation of the workpiece 20 is assumed with the installation position of the observation device 2 as the fixed dedicated sensor and the controlled device 4 as the articulated robot arm. In FIG. 13, the workpiece 20 is illustrated as one workpiece as in the first example embodiment. However, the shape and the number of the workpieces 20 to be the subject of the objective task are not limited to the workpieces 20 illustrated in FIG. 13. In addition, as in the second and third example embodiments, the control system 100 may include a plurality of controlled devices 4, or the evaluation device 5 may be added. However, the control system 100 is not limited to the environment and configuration illustrated in FIG. 13.

### (Advantages)

As a result, the control system 100 can achieve precise control of the controlled device according to the control system.

### Second Application Example

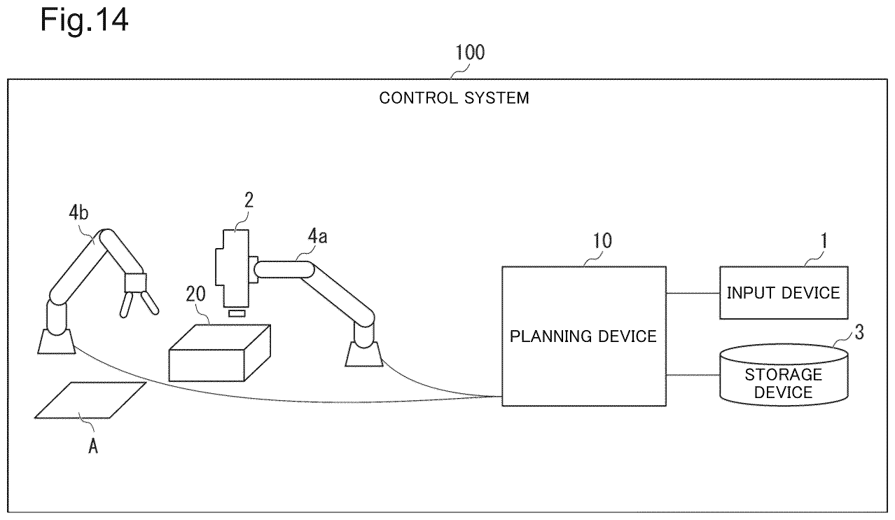

The second application example is an application example in which the controlled devices 4a to 4m of the control system 100 in the second or third example embodiment are articulated robot arms, a specific region (area) Ak is added, and the system is applied to an objective task accompanied by not only observation of a workpiece but also an operation. FIG. 14 is a diagram illustrating the second application example of the control system 100 according to the first example embodiment of the present disclosure. FIG. 14 illustrates a configuration example of the control system 100 as the present application example. The configuration other than the above is the same as that of the second or third example embodiment, and thus the description thereof is omitted.

In the example of the environment and the configuration of the control system 100 illustrated in FIG. 14 illustrating the second application example, the observation device 2 is mounted on the robot arm of the controlled device 4a. That is, the observation device 2 can change the position and the posture by the controlled device 4a. In the drawings before the second application example, the environment is indicated only by the block. However, in FIG. 14, the environment indicates that the robot arm is disposed and that the conveyance destination (area A) exists. The controlled device 4b has an end effector such as a robot hand that can grip the workpiece 20 and change the position and the posture. In the second application example, the position and the posture of the workpiece 20 are changed by the controlled device 4b. The control system 100 may not include the end effector. As in the present application example, the controlled devices 4a to 4m may perform different roles. Specifically, there is a degree of freedom in handling of each controlled device and a logical variable for determining control. For example, as in the above example, the controlled device 4a may be controlled based on the logical variable ac that determines the control of the observation device 2, and the controlled device 4b may be controlled based on the logical variable δw that determines the control of the workpiece 20. In the present application example, an area A indicating a specific region (area) is added. This can be used as a target value of a conveyance destination to convey the workpiece 20 as an example. Specifically, a task of “image the workpiece 20 and convey the workpiece to the area A” can be given as the target task. Such a target task can be represented, for example, by the proposition “c” “the position Xw of the workpiece 20 finally exists in the area A”. As a result, the target task in the entire process including the imaging of the workpiece 20 and the avoidance of contact with an obstacle can be expressed as, for example, “(?ai)#(?c)#(@!h)”. However, there is a constraint condition that the objective task “c” to be conveyed to the area A is executed after the imaging objective task “ai”. This constraint condition can be set, for example, as a condition representing the ordinality between the logical variable θi representing observability and the logical variable for determining the control for conveying to the area A. The controlled device 4b may be used for control for changing the position and the posture of the workpiece 20 before conveyance to the area A. In this operation, as described in the above-described example embodiment, since the condition that the change in the position and the posture of the workpiece 20 has been completed before imageable, the constraint condition of the order relation is satisfied. The environment and the above operation illustrated in FIG. 14 are merely examples, and the present invention is not limited thereto. For example, there may be a plurality of areas A and a plurality of workpieces 20, and the areas may be different for each workpiece. The area of the conveyance destination may be changed based on the result of the evaluation by the evaluation device 5.

The control system 100 of the second application example described above has been described. In general, ordinality between tasks and ordinality between controlled devices is important for task planning involving such complex control. Therefore, in general, there is a possibility that it takes time and effort to generate a plan or a malfunction occurs in the operation of the controlled device due to generation of an inappropriate plan. The control system 100 of the second application example has a feature in which different objective tasks, that is, propositions are associated with a plurality of controlled devices 4a to 4m, so that a composite task (objective task of the entire process) such as imaging and conveyance can be executed. Therefore, the control system 100 of the second application example generates an optimal operation plan without the user being concerned only by setting constraint conditions between logical variables even for a complex and composite task including different objective tasks. Therefore, the control system 100 of the second application example has an effect of being able to reduce the possibility as described above.

In the control system 100 of the second application example, the controlled devices 4a to 4m are articulated robot arms, a specific region (area) is added, and a composite objective task such as imaging and conveyance is assumed. However, the number of controlled devices 4a to 4m, the number of workpieces 20, the number of areas, and the like in the control system 100 of the second application example are not limited to the example of the control system 100 illustrated in FIG. 14. In addition, in the above description, imaging and conveyance to an area are the objective tasks, but the present application example is not limited thereto.

### (Advantages)

As a result, the control system 100 can achieve precise control of the controlled device according to the control system.

### Third Application Example

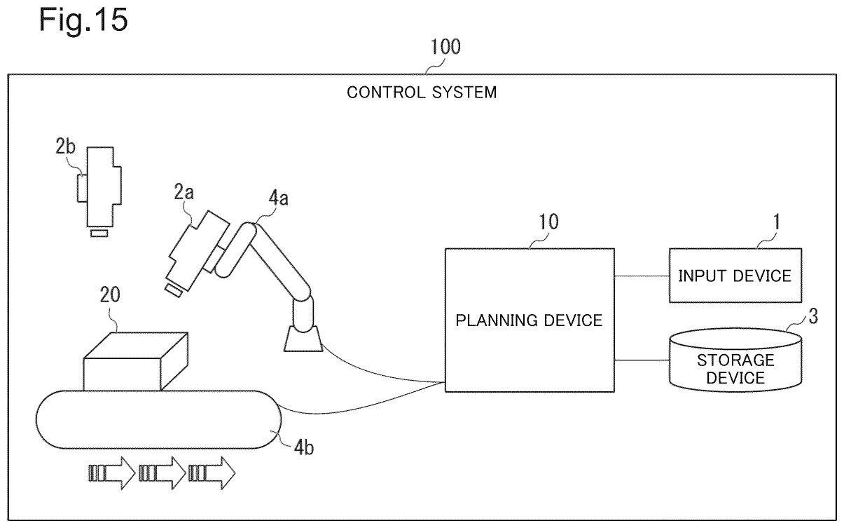

The third application example is an application example in which the observation device 2 of the control system 100 in the second or third example embodiment is a plurality of observation devices (for example, the observation devices 2a and 2b), and the controlled devices 4a to 4m are devices such as a belt conveyor that conveys the articulated robot arm and the workpiece 20. FIG. 15 is a diagram illustrating the third application example of the control system 100 according to the first example embodiment of the present disclosure. FIG. 15 illustrates a configuration example of a control system 100 in the present application example. The configuration other than the above is the same as that of the second or third example embodiment, and thus the description thereof is omitted.

The example of the control system 100 illustrated in FIG. 15 is first characterized by including a plurality of observation devices 2a and 2b. For example, as in the first example embodiment, it is assumed that the observation device 2a executes an imaging task for the workpiece 20 and is mounted on the controlled device 4a, so that the position and the posture thereof can be changed. The observation device 2b is an observation device whose installation position is fixed as in the first application example, and can acquire state information about an object in the environment including the workpiece 20. Specifically, in the above-described example embodiment, the means for acquiring the position and posture information about the workpiece or the object serving as an obstacle may be any means. However, in the present application example, it is assumed that the observation device 2b is used as this means. That is, the observation device 2b acquires the observation information for estimating the position and the posture of the object in the environment including the workpiece 20, preferably, the three dimensional state vector as the position and the three dimensional state vector as the posture. The method of estimating a state vector based on this observation information is similar to the method described in the first example embodiment. Another feature includes a difference in types between the controlled device 4a and the controlled device 4b. In the example embodiment of the present disclosure, there is no particular limitation on what the controlled device 4 is, and only the assumption is that the movable unit (actuator) of the controlled device 4 can be controlled based on the operation plan output by the planning device 10. Therefore, the controlled device 4b such as the belt conveyor illustrated in FIG. 15 can be handled. Specifically, the workpiece 20 is placed on the movable unit of the controlled device 4b and a target point is input, so that control is performed to convey the workpiece 20 to the target value. In other words, the position of the workpiece 20 is changed by the controlled device 4b. Therefore, the control system 100 can be made to be related to the logical variable δw that determines the control of the position of the workpiece 20. For example, the control system 100 can control to move the workpiece 20 when the value of the logical variable δw is 1 and stop the workpiece 20 when the value of the logical variable δw is 0.

Next, features of the present application example will be described. First, since there is a plurality of observation devices, the observation devices can be used in cooperation or in cooperation. Specific examples thereof will be described below. In the above-described example, while it is assumed that the observation device 2b can acquire the observation information about the object in the environment including the workpiece 20, there is a method of, for example, setting a proposition “d” that “the workpiece 20 can be observed”, and setting that the proposition “d” is 1 (true) as a constraint condition before the control of the workpiece 20. Since the observation device 2a is responsible for an imaging task of the workpiece 20 as an objective task, the observation device 2a may output observation information about the workpiece 20. However, as described above, since it is determined that depending on the position of the workpiece 20 or the configuration of the environment such as an obstacle, by the observation device 2a or the observation device 2b, either the observation device 2a or the observation device 2b can perform observation or neither the observation device 2a nor the observation device 2b can perform observation, it is difficult to determine in advance by which of the observation devices observation is to be performed, and there is a possibility that it is difficult to set conditions and threshold values for determination. In such a case, using the present application example, for example, it is possible to add a logical variable for determining to observe the workpiece by the observation device 2b independently of the logical variable θi for determining to observe the workpiece by the observation device 2a described above, and further add the proposition “d”. By solving the optimization problem with this configuration, which of the observation devices 2a and 2b is appropriate to perform observation is output as the value of the logical variable. Therefore, the control system 100 has an effect of reducing the above-described preset possibility. One of the features of the present application example is that the target controlled device is not limited to the robot arm as in the illustrated belt conveyor as the controlled device 4b.

The control system 100 of the third application example which includes the plurality of observation devices 2a and 2b and in which the controlled devices 4a to 4m are devices such as a belt conveyor that conveys the articulated robot arm and the workpiece 20 is described above. However, the number, type, and configuration of the observation devices 2, and the number, type, and configuration of the controlled devices 4a to 4m, and the number, type, and shape of the workpieces 20 are not limited to the control system 100 illustrated in FIG. 15.

### (Advantages)

As a result, the control system 100 can achieve precise control of the controlled device according to the control system.

The present invention is described above with the above-described example embodiments and application examples as examples. However, the present invention is not limited to the content described above. The present invention can be applied to various forms without departing from the gist of the present invention.

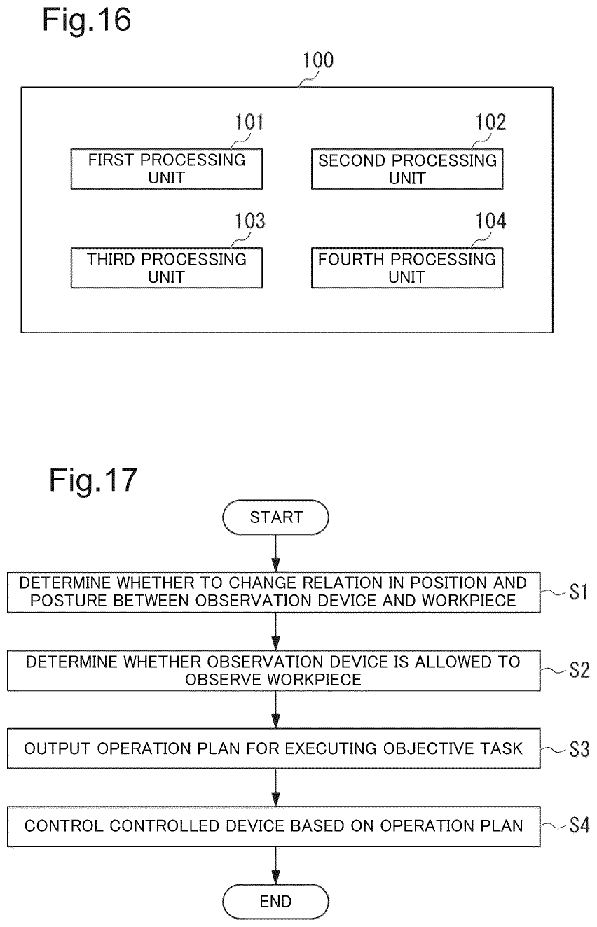

The control system 100 having a minimum configuration according to an example embodiment of the present disclosure will be described. FIG. 16 is the diagram illustrating a control system 100 having a minimum configuration according to an example embodiment of the present disclosure. As illustrated in FIG. 16, a control system 100 having a minimum configuration according to an example embodiment of the present disclosure includes a first processing unit 101 (an example of a first processing means), a second processing unit 102 (an example of a second processing means), a third processing unit 103 (an example of a third processing means), and a fourth processing unit 104 (an example of a fourth processing means). The first processing unit 101 determines whether to change the relation in position and posture between the observation device and the workpiece based on at least any of information regarding an objective task input by an input device, observation device information about an observation device that achieves the objective task, object model information about a workpiece to be a subject of the objective task, controlled device information about a controlled device that changes the relation in position and posture between the observation device and the workpiece, and constraint condition information to be satisfied in order to achieve the objective task. The first processing unit 101 can be achieved, for example, by using a function of the operation determination unit 11 illustrated in FIG. 1. The second processing unit 102 determines whether the observation device is allowed to observe the workpiece. The second processing unit 102 can be achieved by using, for example, a function of the observation determination unit 12 illustrated in FIG. 1. The third processing unit 103 outputs an operation plan for executing the objective task based on the determination result by the second processing unit 102. The third processing unit 103 can be achieved, for example, by using a function of the plan generation unit 13 illustrated in FIG. 1. The fourth processing unit 104 controls the controlled device based on the operation plan. The fourth processing unit 104 can be achieved by using, for example, the functions of the control device 6 illustrated in FIG. 1.

Next, processing of the control system 100 having the minimum configuration of the present disclosure will be described. FIG. 17 is a diagram illustrating an example of a processing flow of the control system having the minimum configuration of the present disclosure. Processing of the control system 100 having the minimum configuration will be described with reference to FIG. 17.

The first processing unit 101 determines whether to change the relation in position and posture between the observation device and the workpiece based on at least any of information regarding an objective task input by an input device, observation device information about an observation device that achieves the objective task, object model information about a workpiece to be a subject of the objective task, controlled device information about a controlled device that changes the relation in position and posture between the observation device and the workpiece, and constraint condition information to be satisfied in order to achieve the objective task (step S1). The second processing unit 102 determines whether the observation device is allowed to observe the workpiece (step S2). The third processing unit 103 outputs an operation plan for executing the objective task based on the determination result by the second processing unit 102 (step S3). The fourth processing unit 104 controls the controlled device based on the operation plan (step S4).

### (Advantages)

As a result, the control system 100 can achieve precise control of the controlled device according to the control system.

The sequence of processing in the example embodiments of the present disclosure may be changed within a range in which appropriate processing is performed.

Although the example embodiments of the present disclosure are described, the control system 100, the control device 6, and other control devices described above may include a computer device therein. The process of the above-described processing is stored in a computer-readable recording medium in the form of a program, and the above-described processing is performed by the computer reading and executing the program. A specific example of the computer will be described below.

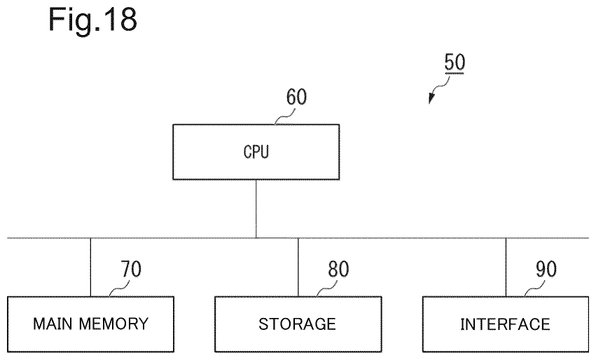

FIG. 18 is a schematic block diagram illustrating a configuration of a computer according to at least one example embodiment. As illustrated in FIG. 18, the computer 50 includes a CPU 60, a main memory 70, a storage 80, and an interface 90. For example, each of the control system 100, the control device 6, and other control devices described above is mounted on the computer 50. The operation of each processing unit described above is stored in the storage 80 in the form of a program. The CPU 60 reads the program from the storage 80, develops the program in the main memory 70, and executes the above processing according to the program. The CPU 60 secures a storage region related to each of the above-described storage units in the main memory 70 according to the program.

Examples of the storage 80 include a hard disk drive (HDD), a solid state drive (SSD), a magnetic disk, a magneto-optical disk, a compact disc read only memory (CD-ROM), a digital versatile disc read only memory (DVD-ROM), a semiconductor memory, and the like. The storage 80 may be an internal medium directly connected to a bus of the computer 50, or may be an external medium connected to the computer 50 via the interface 90 or a communication line. In a case where this program is distributed to the computer 50 via a communication line, the computer 50 that has received the distribution may expand the program in the main memory 70 and execute the above processing. In at least one example embodiment, the storage 80 is a non-transitory tangible storage medium.

The program may achieve part of the functions described above. Furthermore, the program may be a file that can achieve the above-described functions in combination with a program already recorded in the computer device, that is, a so-called difference file (difference program).

Although some example embodiments of the present disclosure have been described, these example embodiments are examples and do not limit the scope of the disclosure. Various additions, omissions, substitutions, and changes may be made to these example embodiments without departing from the gist of the disclosure.

Some or all of the above example embodiments may be denoted as the following Supplementary Notes, but are not limited to the following.

### (Supplementary Note 1)

A control system including
a first processing means for determining, based on at least one piece of information of information about an objective task input by an input device, observation device information about an observation device that achieves the objective task, object model information about a workpiece to be subject of the objective task, controlled device information about a controlled device that changes a relation in position and posture between the observation device and the workpiece, and constraint condition information to be satisfied for achieving the objective task, whether to change the relation in position and posture between the observation device and the workpiece,
a second processing means for determining whether the observation device is allowed to observe the workpiece,
a third processing means for outputting, based on a result of determination by the second processing means, plan information for executing the objective task, and
a fourth processing means for controlling the controlled device based on the plan information.

### (Supplementary Note 2)

The control system according to Supplementary Note 1, wherein
each of the first processing means and the second processing means outputs a determination result based on abstraction state information related to an abstraction state in a work space in which the objective task is executed.

### (Supplementary Note 3)

The control system according to Supplementary Note 1 or 2, wherein
the third processing means outputs the plan information based on abstraction state information related to an abstraction state in a work space in which the objective task is executed and abstraction model information related to a temporal or spatial change in the abstraction state.

### (Supplementary Note 4)

The control system according to any one of Supplementary Notes 1 to 3, wherein
the third processing means outputs the plan information in units of subtasks by associating a change in an abstraction state related to an abstraction state in a work space in which the objective task is executed with a subtask based on subtask information related to a subtask in which an operation necessary for completing the objective task is decomposed, and
the fourth processing means controls the controlled device in units of the subtasks.

### (Supplementary Note 5)

The control system according to any one of Supplementary Notes 1 to 4, wherein
the abstraction state included in abstraction model information related to an abstraction state in a work space in which the objective task is executed includes a continuous variable that allows a continuous change and a logical variable representing a logical value, and determination by the first processing means and the second processing means is related to the logical variable, and
the third processing means outputs temporal changes of the continuous variable and the logical variable as the plan information.

### (Supplementary Note 6)

The control system according to any one of Supplementary Notes 1 to 5, wherein
the controlled device includes a plurality of the controlled devices, and control of each of the controlled devices is associated with a continuous variable that allows a continuous change and a logical variable representing a logical value.

### (Supplementary Note 7)

The control system according to any one of Supplementary Notes 1 to 6, wherein
the third processing means outputs plan information including information about an execution order of a subtask for each time based on subtask information about a subtask in which an operation necessary for completing the objective task is decomposed and a temporal change in each of a continuous variable that allows a continuous change and a logical variable representing a logical value, and
the fourth processing means executes control of each subtask and each controlled device in an execution order based on the plan information even in a case where the number of the fourth processing means is one or two or more.

### (Supplementary Note 8)

The control system according to any one of Supplementary Notes 1 to 7, further including
an evaluation device that outputs an evaluation result of observation information acquired by the observation device, wherein the second processing means makes determination based on the evaluation result.

### (Supplementary Note 9)

A control method including
determining, based on at least one piece of information of information about an objective task input by an input device, observation device information about an observation device that achieves the objective task, object model information about a workpiece to be subject of the objective task, controlled device information about a controlled device that changes a relation in position and posture between the observation device and the workpiece, and constraint condition information to be satisfied for achieving the objective task, whether to change the relation in position and posture between the observation device and the workpiece,
determining whether the observation device is allowed to observe the workpiece,
outputting, based on a determination result, plan information for executing the objective task, and
controlling the controlled device based on the plan information.

### (Supplementary Note 10)

A recording medium storing a program for causing a computer to execute the steps of
determining, based on at least one piece of information of information about an objective task input by an input device, observation device information about an observation device that achieves the objective task, object model information about a workpiece to be subject of the objective task, controlled device information about a controlled device that changes a relation in position and posture between the observation device and the workpiece, and constraint condition information to be satisfied for achieving the objective task, whether to change the relation in position and posture between the observation device and the workpiece,
determining whether the observation device is allowed to observe the workpiece,
outputting, based on a determination result, plan information for executing the objective task, and
controlling the controlled device based on the plan information.

### INDUSTRIAL APPLICABILITY

According to the control system of the present disclosure, it is possible to achieve precise control of the controlled device.

### REFERENCE SIGNS LIST

1 input device
2, 2a, 2b observation device
3 storage device
4, 4a, . . . 4m controlled device
5 evaluation device
6 control device
11 operation determination unit
12 observation determination unit
13 plan generation unit
20 workpiece
21 obstacle
100 control system

What is claimed is:

1. A control system comprising:
at least one memory storing instructions; and
at least one processer configured to execute the instructions to perform:
determining, based on at least one piece of information of information about an objective task input by an input device, observation device information about an observation device that achieves an objective task, object model information about a workpiece to be subject of the objective task, controlled device information about a controlled device that changes a relation in position and posture between the observation device and the workpiece, and constraint condition information to be satisfied for achieving the objective task, whether to change a relation in position and posture between the observation device and the workpiece;
determining whether the observation device is allowed to observe the workpiece; and
outputting, based on a result of determination by the second processing means, plan information for executing the objective task, and
a controller for controlling the controlled device based on the plan information.

2. The control system according to claim 1, wherein
the at least one processer is configured to execute the instructions to perform:
outputting the result of determination based on an abstraction state in a work space in which the objective task is executed.

3. The control system according to claim 1, wherein
the at least one processer is configured to execute the instructions to perform:
outputting the plan information based on an abstraction state in a work space in which the objective task is executed and a temporal or spatial change in the abstraction state.

4. The control system according to claim 1, wherein
the at least one processer is configured to execute the instructions to perform:
outputting the plan information in units of subtasks by associating a change in an abstraction state in a work space in which the objective task is executed with a subtask based on a subtask in which an operation necessary for completing an objective task is decomposed, and
the controller controls the controlled device in units of the subtasks.

5. The control system according to claim 1, wherein
abstraction model information related to an abstraction state in a work space in which the objective task is executed includes a continuous variable that allows a continuous change and a logical variable representing a logical value, and the determination is related to the logical variable, and
the at least one processer is configured to execute the instructions to perform:
outputting temporal changes of the continuous variable and the logical variable as the plan information.

6. The control system according to claim 1, wherein
the controlled device includes a plurality of the controlled devices, and control of each of the controlled devices is associated with a continuous variable that allows a continuous change and a logical variable representing a logical value.

7. The control system according to claim 1, wherein
the at least one processer is configured to execute the instructions to perform:
outputting plan information including information about an execution order of a subtask for each time based on a subtask in which an operation necessary for completing the objective task is decomposed and a temporal change in each of a continuous variable that allows a continuous change and a logical variable representing a logical value, and
the controller executes control of each subtask and each controlled device in an execution order based on the plan information.

8. The control system according to claim 1, further comprising:
an evaluation device that outputs an evaluation result of observation information acquired by the observation device, wherein
the at least one processer is configured to execute the instructions to perform: making the determination whether the observation device is allowed to observe the workpiece based on the evaluation result.

9. A control method comprising:
determining, based on at least one piece of information of information about an objective task input by an input device, observation device information about an observation device that achieves an objective task, object model information about a workpiece to be subject of the objective task, controlled device information about a controlled device that changes a relation in position and posture between the observation device and the workpiece, and constraint condition information to be satisfied for achieving the objective task, whether to change a relation in position and posture between the observation device and the workpiece;
determining whether the observation device is allowed to observe the workpiece;
outputting, based on the result of determination, plan information for executing the objective task; and
controlling the controlled device based on the plan information.

10. A non-transitory recording medium storing a program for causing a computer to execute the steps of:
determining, based on at least one piece of information of information about an objective task input by an input device, observation device information about an observation device that achieves an objective task, object model information about a workpiece to be subject of the objective task, controlled device information about a controlled device that changes a relation in position and posture between the observation device and the workpiece, and constraint condition information to be satisfied for achieving the objective task, whether to change a relation in position and posture between the observation device and the workpiece;
determining whether the observation device is allowed to observe the workpiece;
outputting, based on the result of determination, plan information for executing the objective task; and
controlling the controlled device based on the plan information.
